(19) United States
(12) Patent Application Publication
(10) Pub. No.: US 2024/0409383 A1
(43) Pub. Date: Dec. 12, 2024

(54) BOOM ASSEMBLY HAVING AN ADAPTER

(71) Applicant: Crown Equipment Corporation, New Bremen, OH (US)

(72) Inventors: Derek Vermeulen, La Grange, NC (US); Clinton Reges, Greenville, NC (US); John Tinker, Greenville, NC (US)

(21) Appl. No.: 18/733,161

(22) Filed: Jun. 4, 2024

Related U.S. Application Data
(60) Provisional application No. 63/506,894, filed on Jun. 8, 2023.
(60) Provisional application No. 63/578,672, filed on Aug. 25, 2023.
(60) Provisional application No. 63/578,769, filed on Aug. 25, 2023.

(51) Int. Cl. B66F 17/00; B66F 9/12

(52) U.S. Cl. CPC B66F 17/003

(57) ABSTRACT

A boom assembly including an upper boom portion, a base mount, and an adapter coupling the base mount to the upper boom portion, in which the adapter is configured to (i) maintain the boom assembly in a normal operating position when the upper boom portion is subjected to one or more external forces causing one or more internal forces in the adapter below a yield force threshold of the adapter; and (ii) yield when the upper boom portion is subjected to one or more external forces causing one or more internal forces in the adapter equal to or in excess of the yield force threshold of the adapter. Also provided is a materials handling vehicle including a boom assembly.

### RELATED APPLICATIONS

This application claims the benefit of U.S. Provisional Application No. 63/506,894, filed Jun. 8, 2023, entitled “BOOM ASSEMBLY HAVING AN ADAPTER” (Attorney Docket No. 2304/CRN1079MA); U.S. Provisional Application No. 63/578,672, filed Aug. 25, 2023, entitled “BOOM ASSEMBLY HAVING AN ADAPTER” (Attorney Docket No. 2304/CRN1079MA2); and U.S. Provisional Application No. 63/578,769, filed Aug. 25, 2023, entitled “INTEGRITY MONITORING SYSTEM FOR A BOOM ASSEMBLY” (Attorney Docket No. 2318/CRN1079MA3), the disclosures of which are herein incorporated by reference in their entirety.

### TECHNICAL FIELD

The present disclosure relates to a boom assembly having an adapter and more specifically to a boom assembly having a yielding adapter that allows for controlled failure of the boom assembly.

### BACKGROUND

A boom assembly may be used to position an accessory such as a camera at a desired vertical and/or horizontal position.

### SUMMARY

In accordance with a first aspect of the present disclosure, a boom assembly is provided comprising: an upper boom portion; a base mount; and an adapter fixedly coupled to the base mount and coupling the base mount to the upper boom portion. The adapter may comprise at least one coupling member. The adapter may be configured to (i) maintain the boom assembly in a normal operating position when the upper boom portion is subjected to one or more external forces causing one or more internal stresses in the at least one coupling member below a yield stress threshold of the at least one coupling member; and (ii) yield when the upper boom portion is subjected to one or more external forces causing one or more internal stresses in the at least one coupling member equal to or in excess of the yield stress threshold of the at least one coupling member such that the at least one coupling member plastically deforms to allow controlled movement of the upper boom portion to a final deformed angular position relative to the base mount. Once the one or more external forces causing the one or more internal stresses in the at least one coupling member equal to or in excess of the yield stress threshold of the at least one coupling member are removed, the at least one coupling member further holds the upper boom portion at the final deformed angular position to prevent free-falling over of the upper boom portion.

When the upper boom portion is in the final deformed angular position, the upper boom portion may be held in a fixed position relative to the base mount after the one or more external forces are removed.

The adapter may comprise first and second upper plate mounts and first and second lower plate mounts. The at least one coupling member may comprise: a first coupling plate joined to the first upper plate mount and the first lower plate mount, wherein the first upper plate mount may be coupled to the upper boom portion and the first lower plate mount may be coupled to the base mount; and a second coupling plate joined to the second upper plate mount and the second lower plate mount, wherein the second upper plate mount may be coupled to the upper boom portion and the second lower plate mount may be coupled to the base mount.

When the upper boom portion is subjected to one or more external forces having a force component extending in a first direction causing one or more internal stresses in each of the first and second coupling plates equal to or in excess of the yield stress threshold of each of the first and second coupling plates, the first and second coupling plates may deform and allow the upper boom portion to rotate in a first bending direction. When the upper boom portion is subjected to one or more external forces having a force component extending in a second direction opposite to the first direction causing one or more internal stresses in each of the first and second coupling plates equal to or in excess of the yield stress threshold of each of the first and second coupling plates, the first and second coupling plates may deform and allow the upper boom portion to rotate in a second bending direction.

The adapter may be configured such that the upper boom portion remains connected to the base mount after the first and second coupling plates deform.

The second upper and lower plate mounts may provide a first stop that limits rotation of the upper boom portion in the first bending direction. The first upper and lower plate mounts may provide a second stop that limits rotation of the upper boom portion in the second bending direction.

The at least one coupling member may comprise a first coupling bar and a second coupling bar. The first and second coupling bars may each be coupled to the upper boom portion and the base mount. When the upper boom portion is subjected to one or more external forces having a force component extending in a first direction causing one or more internal stresses in each of the first and second coupling bars equal to or in excess of the yield stress threshold of each of the first and second coupling bars, the first and second coupling bars deform and allow the upper boom portion to rotate in a first bending direction. When the upper boom portion is subjected to one or more external forces having a force component extending in a second direction opposite to the first direction causing one or more internal stresses in each of the first and second coupling bars equal to or in excess of the yield stress threshold of each of the first and second coupling bars, the first and second coupling bars deform and allow the upper boom portion to rotate in a second bending direction.

The first and second coupling bars may each comprise: an upper section coupled to the upper boom portion; a lower section coupled to the base mount; and a middle section joining the upper and lower sections, wherein the upper and lower sections each comprise a width and a depth that are substantially equal, and wherein the middle section comprises at least one of a decreased width or a decreased depth as compared to the width and depth of the upper and lower sections.

A first portion of an upper end surface of the base mount and a first portion of a lower end surface of the upper boom portion may provide a first stop that limits rotation of the upper boom portion in the first bending direction; and a second portion of the upper end surface of the base mount and a second portion of the lower end surface of the upper boom portion may provide a second stop that limits rotation of the upper boom portion in the second bending direction.

The base mount may comprise a first cross-sectional shape and the upper boom portion may comprise a second cross-sectional shape that is different from the first cross-sectional shape, wherein the boom assembly may further comprise a connector that transitions from the first cross-sectional shape to the second cross-sectional shape.

In accordance with a second aspect, a materials handling vehicle is provided comprising: a power unit; a load handling assembly extending from the power unit and comprising a pair of forks; an operator's station comprising an operator's backrest and an operator's platform; and a boom assembly coupled to an element of the materials handling vehicle, wherein the boom assembly may comprise a base mount, an upper boom portion, and an adapter coupling the base mount to the upper boom portion. The adapter may comprise at least one coupling member. The base mount may comprise a main body extending generally vertically above the operator's platform. The upper boom portion may comprise a first section extending generally vertically above the operator's platform. The adapter may be configured to (i) maintain the boom assembly in a normal operating position when the upper boom portion is subjected to one or more external forces causing one or more internal stresses in the at least one coupling member below a yield stress threshold of the at least one coupling member; and (ii) yield when the upper boom portion is subjected to one or more external forces causing one or more internal stresses in the at least one coupling member equal to or in excess of the yield stress threshold of the at least one coupling member such that the at least one coupling member plastically deforms to allow controlled movement of the upper boom portion to a final deformed angular position relative to the base mount. The one or more external forces causing the one or more internal stresses in the at least one coupling member equal to or in excess of the yield stress threshold of the at least one coupling member cause the at least one coupling member to deform prior to the element of the materials handling vehicle yielding. Once the one or more external forces causing the one or more internal stresses in the at least one coupling member equal to or in excess of the yield stress threshold of the at least one coupling member are removed, the at least one coupling member may further hold the upper boom portion at the final deformed angular position to prevent free-falling over of the upper boom portion.

When the upper boom portion is in the final deformed angular position, the upper boom portion may be held in a fixed position relative to the base mount after the one or more external forces are removed.

The adapter may comprise first and second upper plate mounts and first and second lower plate mounts, and wherein the at least one coupling member may comprise: a first coupling plate joined to the first upper plate mount and the first lower plate mount, wherein the first upper plate mount may be coupled to the upper boom portion and the first lower plate mount is coupled to the base mount; and a second coupling plate joined to the second upper plate mount and the second lower plate mount, wherein the second upper plate mount is coupled to the upper boom portion and the second lower plate mount is coupled to the base mount.

When the upper boom portion is subjected to one or more external forces having a force component extending in a first direction causing one or more internal stresses in each of the first and second coupling plates equal to or in excess of the yield stress threshold of each of the first and second coupling plates, the first and second coupling plates may deform and allow the upper boom portion to rotate in a first bending direction. When the upper boom portion is subjected to one or more external forces having a force component extending in a second direction opposite to the first direction causing one or more internal stresses in each of the first and second coupling plates equal to or in excess of the yield stress threshold of each of the first and second coupling plates, the first and second coupling plates may deform and allow the upper boom portion to rotate in a second bending direction.

The adapter may be configured such that the upper boom portion remains connected to the base mount after the first and second coupling plates deform.

The second upper and lower plate mounts may provide a first stop that limits rotation of the upper boom portion in the first bending direction. The first upper and lower plate mounts may provide a second stop that limits rotation of the upper boom portion in the second bending direction.

The at least one coupling member may comprise a first coupling bar and a second coupling bar, the first and second coupling bars each being coupled to the upper boom portion and the base mount.

When the upper boom portion is subjected to one or more external forces having a force component extending in a first direction causing one or more internal stresses in each of the first and second coupling bars equal to or in excess of the yield stress threshold of each of the first and second coupling bars, the first and second coupling bars may deform and allow the upper boom portion to rotate in a first bending direction. When the upper boom portion is subjected to one or more external forces having a force component extending in a second direction opposite to the first direction causing one or more internal stresses in each of the first and second coupling bars equal to or in excess of the yield stress threshold of each of the first and second coupling bars, the first and second coupling bars may deform and allow the upper boom portion to rotate in a second bending direction.

The first and second coupling bars may each comprise: an upper section coupled to the upper boom portion; a lower section coupled to the base mount; and a middle section joining the upper and lower sections, wherein the upper and lower sections may each comprise a width and a depth that are substantially equal, and wherein the middle section may comprise at least one of a decreased width or a decreased depth as compared to the width and depth of the upper and lower sections.

A first portion of an upper end surface of the base mount and a first portion of a lower end surface of the upper boom portion may provide a first stop that limits rotation of the upper boom portion in the first bending direction; and a second portion of the upper end surface of the base mount and a second portion of the lower end surface of the upper boom portion may provide a second stop that limits rotation of the upper boom portion in the second bending direction.

The base mount may comprise a first cross-sectional shape and the upper boom portion may comprise a second cross-sectional shape that is different from the first cross-sectional shape. The boom assembly may further comprise a connector that transitions from the first cross-sectional shape to the second cross-sectional shape.

An accessory may be coupled to a distal end of the upper boom portion.

In accordance with a third aspect, a boom assembly is provided comprising: an upper boom portion; a base mount; and an adapter fixedly coupled to the base mount and coupling the base mount to the upper boom portion. The adapter may comprise at least one coupling bar or plate. The adapter may be configured to (i) maintain the boom assembly in a normal operating position when the upper boom portion is subjected to one or more external forces causing one or more internal stresses in the at least one coupling bar or plate below a yield stress threshold of the at least one coupling bar or plate; and (ii) yield when the upper boom portion is subjected to one or more external forces causing one or more internal stresses in the at least one coupling bar or plate equal to or in excess of the yield stress threshold of the at least one coupling bar or plate such that the at least one coupling bar or plate plastically deforms to allow controlled movement of the upper boom portion to a final deformed angular position relative to the base mount. Once the one or more external forces causing the one or more internal stresses in the at least one coupling bar or plate equal to or in excess of the yield stress threshold of the at least one coupling bar or plate are removed, the at least one coupling bar or plate may further hold the upper boom portion at the final deformed angular position to prevent free-falling over of the upper boom portion.

When the upper boom portion is in the final deformed angular position, the upper boom portion may be held in a fixed position relative to the base mount after the one or more external forces are removed.

### BRIEF DESCRIPTION OF DRAWINGS

FIG. 1 is a perspective view of a materials handling vehicle comprising a boom assembly with an adapter in accordance with the present disclosure.

FIGS. 2-5 are partially exploded views of a portion of the boom assembly and the materials handling vehicle illustrated in FIG. 1.

FIG. 6 is a detailed perspective view of the portion of the boom assembly and the materials handling vehicle illustrated in FIGS. 2-5 following assembly.

FIGS. 7 and 8 are partially exploded views of a portion of a boom assembly and an adapter with at least one coupling member comprising coupling plates in accordance with the present disclosure.

FIG. 9 is a detailed perspective view of the portion of the boom assembly and the adapter illustrated in FIGS. 7 and 8 following assembly.

FIG. 10 is a cross-sectional view taken through a center of the adapter in FIG. 9.

FIG. 11 is a detailed perspective view of the portion of the boom assembly and the adapter of FIG. 9, in which the adapter comprises a cover.

FIG. 12 is a perspective view of a materials handling vehicle comprising a boom assembly with the adapter of FIG. 9 in a first failed state, in accordance with the present disclosure.

FIG. 13 is a detailed perspective view of the adapter of FIG. 12 and a portion of the boom assembly.

FIG. 14 is a perspective view of a materials handling vehicle comprising a boom assembly with the adapter of FIG. 9 in a second failed state, in accordance with the present disclosure.

FIG. 15 is a detailed perspective view of the adapter of FIG. 14 and a portion of the boom assembly.

FIGS. 16 and 17 are partially exploded views of a portion of a boom assembly and another exemplary adapter with at least one coupling element comprising coupling bars in accordance with the present disclosure.

FIG. 18 is a detailed side view of one of the coupling bars of the adapter of FIGS. 16 and 17.

FIG. 19 is a detailed perspective view of the portion of the boom assembly and the adapter illustrated in FIGS. 16 and 17 following assembly.

FIG. 20 is a detailed perspective view of the portion of the boom assembly and the adapter of FIG. 19, in which the adapter comprises a cover.

FIG. 21 is a perspective view of a materials handling vehicle comprising a boom assembly with the adapter of FIG. 19 in a first failed state, in accordance with the present disclosure.

FIG. 22 is a detailed perspective view of the adapter of FIG. 21 and a portion of the boom assembly.

FIG. 23 is a perspective view of a materials handling vehicle comprising a boom assembly with the adapter of FIG. 19 in a second failed state, in accordance with the present disclosure.

FIG. 24 is a detailed perspective view of the adapter of FIG. 23 and a portion of the boom assembly.

FIGS. 25 and 26 are partially exploded views of a distal end of an upper boom portion, an adapter bracket, and an accessory in accordance with the present disclosure.

FIGS. 27-29 are side views of a materials handling vehicle comprising a boom assembly with an adapter in accordance with the present disclosure.

FIG. 30A is a perspective view of an adapter in accordance with the present disclosure.

FIG. 30B is a cross-sectional view taken along line 30B-30B in FIG. 30A.

FIG. 31 is a cross-sectional view taken through a center of the adapter in FIG. 30.

FIG. 32 is perspective view of an adapter in accordance with the present disclosure.

### DETAILED DESCRIPTION

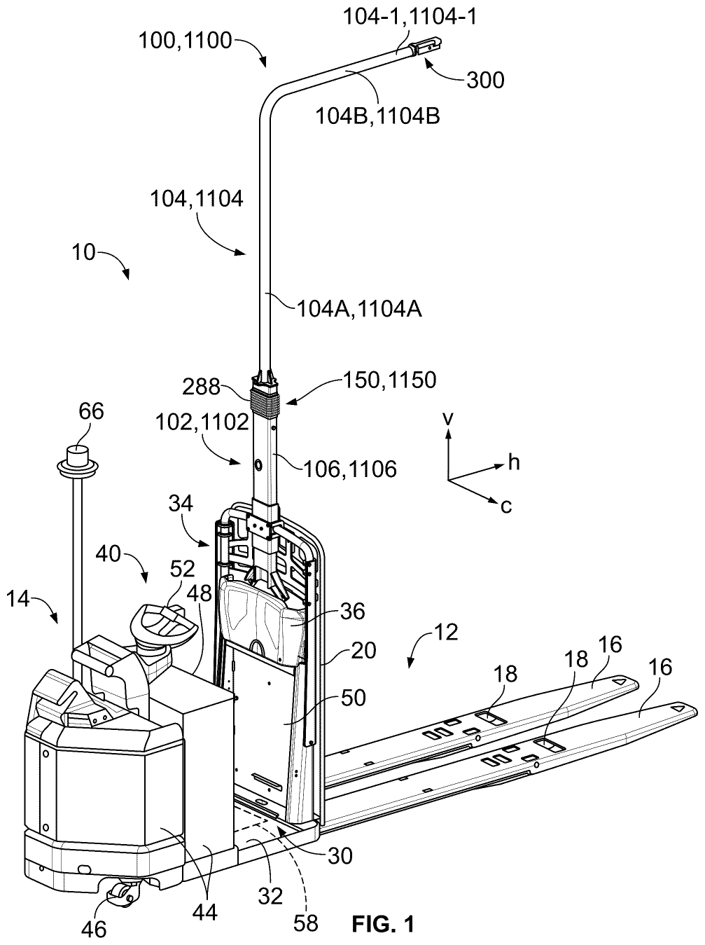

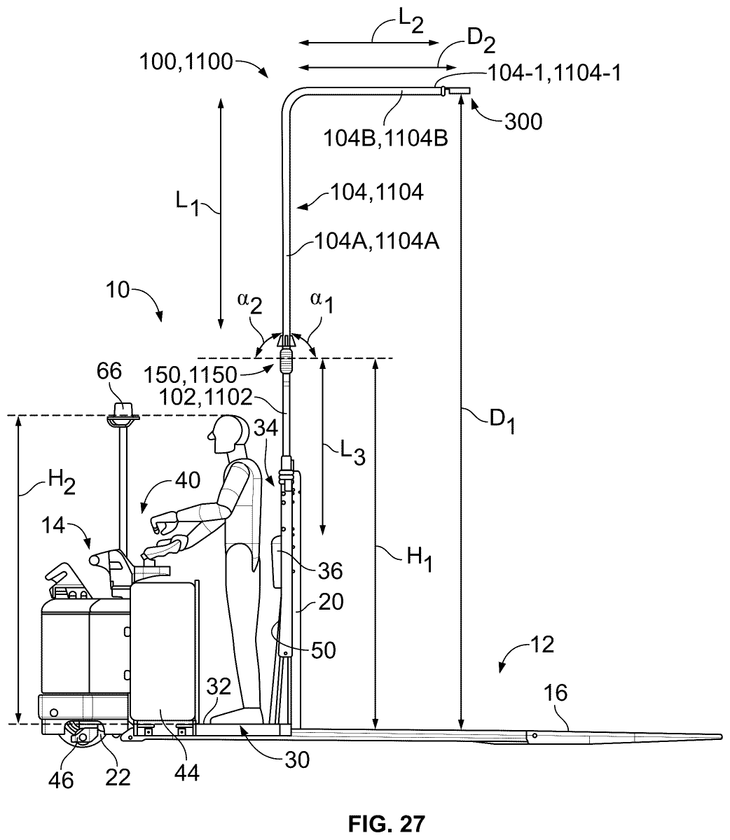

A materials handling vehicle constructed in accordance with the present disclosure is shown in FIGS. 1 and 27. The materials handling vehicle is depicted as a low level order picking truck 10 that includes a load handling assembly 12 extending from a power unit 14. The load handling assembly 12 includes a pair of forks 16, each fork 16 having a load supporting wheel assembly 18. The load handling assembly 12 may include other load handling features in addition to, or in lieu of, the illustrated arrangement of the forks 16, such as scissors-type elevating forks, outriggers, or separate height adjustable forks. Still further, the load handling assembly 12 may include load handling features such as a mast, a load platform, collection cage, or other support structure carried by the forks 16 or otherwise provided for handling a load supported and carried by the truck 10 or pushed or pulled by the truck 10, i.e., such as by a tugger vehicle. A compartment 44 may contain a battery, control electronics, and motor(s) (not shown), such as a traction motor/brake assembly, steer motor, and/or lift motor for the forks 16. The traction motor/brake assembly may be coupled to a steerable drive wheel 22 for driving and braking the drive wheel 22. First and second caster wheels (only the first caster wheel 46 is illustrated) are coupled to opposing sides of the power unit 14.

The illustrated power unit 14 comprises a step-through operator's station 30 defined by an operator's backrest 34, a side wall 48 of the compartment 44, and a floorboard or operator's platform 32. The operator may stand on the operator's platform 32 to drive the truck 10 (see FIG. 27), and/or the operator's platform 32 may provide a position from which the operator may operate the various included features of the truck 10. When the operator is standing on the operator's platform 32, a control area 40 provides for driving the truck 10 and for controlling the features of the load handling assembly 12.

With reference to FIG. 1, as shown for purposes of illustration, and not by way of limitation, the control area 40 comprises a handle 52 for steering the truck 10, which may include controls such as grips, butterfly switches, thumbwheels, rocker switches, a hand wheel, a steering tiller, etc., for controlling the acceleration/braking and travel direction of the truck 10. For example, as shown, a control such as a switch grip (not labeled) may be provided on the handle 52, which is spring biased to a center neutral position. Rotating the switch grip forward and upward will cause the truck 10 to move forward, e.g., power unit first, at an acceleration proportional to the amount of rotation of the switch grip until the truck 10 reaches a predefined maximum speed, at which point the truck 10 is no longer permitted to accelerate to a higher speed. For example, if the switch grip is very quickly rotated 50% of a maximum angle of rotation capable for the grip, the truck 10 will accelerate at approximately 50% of the maximum acceleration capable for the truck 10 until the truck 10 reaches 50% of the maximum speed capable for the truck 10. It is also contemplated that acceleration may be determined using an acceleration map stored in memory where the rotation angle of the grip is used as an input into and has a corresponding acceleration value in the acceleration map. The acceleration values in the acceleration map corresponding to the grip rotation angles may be proportional to the grip rotation angles or vary in any desired manner. There may also be a velocity map stored in memory where the rotation angle of the grip is used as an input into and has a corresponding maximum velocity value stored in the velocity map. For example, when the grip is rotated 50% of the maximum angle capable for the grip, the truck 10 will accelerate at a corresponding acceleration value stored in the acceleration map to a maximum velocity value stored in the velocity map corresponding to the grip angle of 50% of the maximum angle. Similarly, rotating the switch grip downward and toward the rear of the truck 10 will cause the truck 10 to move in reverse, e.g., forks first, at an acceleration proportional to the amount of rotation of the switch grip until the truck 10 reaches a predefined maximum speed, at which point the truck 10 is no longer permitted to accelerate to a higher speed.

One or more proximity or presence sensors 58 may be provided to detect the presence of an operator on the truck 10. For example, presence sensor(s) 58 may be located on, above, or under a floor of the operator's platform 32, or otherwise provided about the operator's station 30. In the exemplary truck 10 of FIG. 1, the presence sensor(s) 58 is/are shown in dashed lines indicating that it/they is/are positioned under the floor of the operator's platform 32. Under this arrangement, the presence sensor(s) 58 may comprise load sensors, switches, etc. As an alternative (not shown), the presence sensor(s) 58 may be implemented above the floor of the operator's platform 32, such as by using ultrasonic, capacitive, or other suitable sensing technology. The presence sensor 58 generates an operator status signal indicating that either an operator is standing on the operator's platform 32 in the operator's station 30 or no operator is standing on the operator's platform 32 in the operator's station 30. A change in the operator status signal indicates that an operator has either entered or exited the operator's station 30.

With continued reference to FIGS. 1 and 27, an antenna 66 extends vertically from the power unit 14 and is provided for receiving control signals from a corresponding wireless remote control device (not shown). It is also contemplated that the antenna 66 may be provided within the compartment 44 of the power unit 14 or elsewhere on the truck 10. The remote control device may comprise a transmitter that is worn or otherwise maintained by the operator. The remote control device is manually operable by an operator, e.g., by pressing a button or other control, to cause the remote control device to wirelessly transmit at least a first type of signal designating a travel request to the truck 10. The travel request is a command that requests the corresponding truck 10 to travel by a predetermined amount.

The truck 10 may also comprise one or more obstacle sensors (not shown), which are provided about the truck 10, e.g., towards a front end of the power unit 14 and/or to the sides of the power unit 14. The obstacle sensor(s) may include at least one contactless obstacle sensor on the truck 10 and may be operable to define at least one detection zone. The obstacle sensor(s) may comprise any suitable proximity detection technology, such as one or more ultrasonic sensors, optical recognition devices, infrared sensors, laser scanner sensors, etc., which may be capable of detecting the presence of objects/obstacles or may be capable of generating signals that can be analyzed to detect the presence of objects/obstacles within the predefined detection zone(s) of the power unit 14.

In practice, the truck 10 may be implemented in other formats, styles and features, such as an end control pallet truck that includes a steering tiller arm that is coupled to a tiller handle for steering the truck. Still further, the truck, remote control system, and/or components thereof, including the remote control device, may comprise any additional and/or alternative features or implementations, examples of which are disclosed in any one or more of the following commonly owned patents/published patent applications: U.S. Pat. No. 9,082,293, issued Jul. 14, 2015 entitled “SYSTEMS AND METHODS OF REMOTELY CONTROLLING A MATERIALS HANDLING VEHICLE”; U.S. Pat. No. 8,072,309, issued Dec. 6, 2011 entitled “SYSTEMS AND METHODS OF REMOTELY CONTROLLING A MATERIALS HANDLING VEHICLE”; U.S. Pat. No. 9,207,673, issued Dec. 8, 2015, entitled “FINGER-MOUNTED APPARATUS FOR REMOTELY CONTROLLING A MATERIALS HANDLING VEHICLE”; and/or U.S. Pat. No. 9,645,968, issued May 9, 2017, entitled “MULTIPLE ZONE SENSING FOR MATERIALS HANDLING VEHICLES”; the entire disclosures of which are each hereby incorporated by reference herein.

As shown in FIGS. 1 and 27, in the example shown, the truck 10 may comprise the operator's backrest 34 and a separate load backrest 20. The operator's backrest 34 faces toward the power unit 14 and is fixed to the operator's platform 32, such that the operator's backrest 34 does not move vertically relative to the operator's platform 32. The load backrest 20, which forms part of the load handling assembly 12 and may move vertically with the other components of the load handling assembly 12, faces toward the forks 16 and serves as a backstop for a load positioned on the forks 16. In other examples (not shown), the truck 10 may comprise a single backrest that serves as both the operator's backrest and the load backrest. The operator's backrest 34 may comprise a wall 50 extending generally vertically above the operator's platform 32 and a support pad 36 coupled to the wall 50. During operation of the truck 10, the operator may stand against the support pad 36.

A boom assembly 100 may be associated with, i.e., coupled to, the truck 10, and an accessory 300 may be coupled to the boom assembly 100. In the example shown in FIGS. 1-6, the boom assembly 100 is removably coupled to the operator's backrest 34, as described herein. In other examples (not shown), the boom assembly 100 may be welded or otherwise secured directly to the operator's backrest 34. In further examples (not shown), the boom assembly 100 may be offset from the operator's backrest 34 and may be secured to another component of the truck 10, such as the load handling assembly 12. The boom assembly 100 may extend above the operator's station 30 and over the forks 16, such that the accessory 300 is positioned above the forks 16. The accessory 300 may comprise, for example, a camera or other imaging device, a light detection and ranging (Lidar) device, a light or object/image projecting device, a sound emitting device, a wireless internet device, or any combination thereof.

With reference to FIGS. 1 and 27, the boom assembly 100 comprises a lower boom portion 102, 1102 (referred to herein as a base mount) and an upper boom portion 104, 1104. The base mount 102, 1102 is coupled to the upper boom portion 104, 1104 via an adapter 150 or 1150 comprising at least one coupling member that yields when the upper boom portion 104, 1104 is subjected to one or more external forces causing internal stresses in the at least one coupling member equal to or in excess of a yield stress threshold of the at least one coupling member, as described herein.

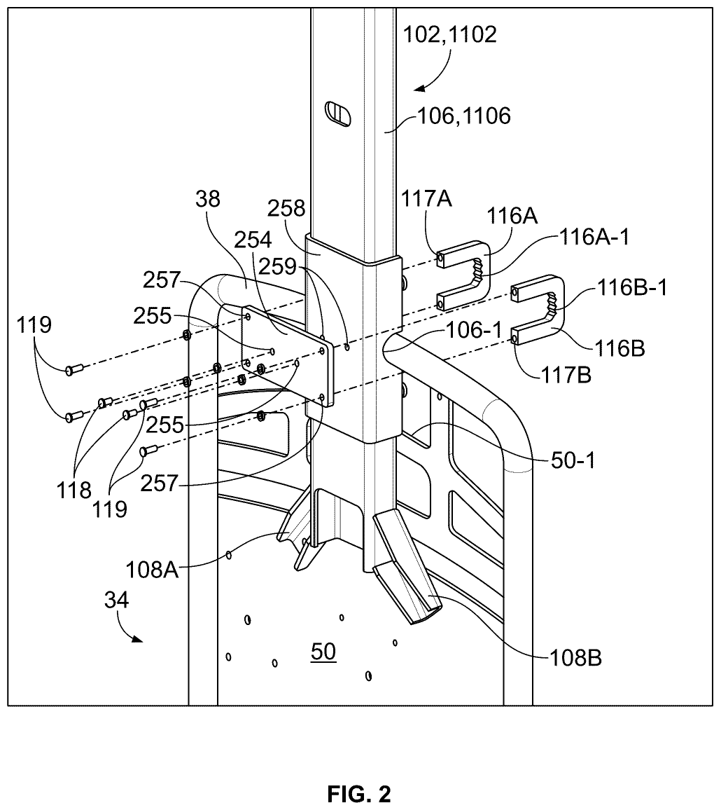

As shown in FIGS. 2-5, the base mount 102 may comprise a main body 106, a first flange 108A, a second flange 108B, a first bracket 116A, and a second bracket 116B. The first and second flanges 108A, 108B are coupled and secured to the main body 106, e.g., via welding. In the example shown, the main body 106 is hollow and comprises a generally rectangular cross-section. In other examples, the main body 106 may comprise a different shape than that shown, such as a circular cross-sectional shape. The base mount 102 may be coupled to the operator's backrest 34 via the first and second flanges 108A, 108B and the first and second brackets 116A, 116B. The first and second flanges 108A, 108B may be positioned on one side of the operator's backrest 34, e.g., facing toward the power unit 14 (not visible in FIG. 2; see FIG. 1), and the first and second brackets 116A, 116B may be positioned opposite the first and second flanges 108A, 108B, e.g., facing toward the forks 16 (not visible in FIG. 2; see FIG. 1).

With reference to FIG. 2, the first and second brackets 116A, 116B may each comprise a “C” shape with a respective notch 116A-1, 116B-1 that fits over and receives a bar 38 comprising an upper portion of the operator's backrest 34. The main body 106 may also comprise a notch 106-1 that fits over and receives the bar 38. A retention plate 254 is positioned opposite the first and second brackets 116A, 116B. The base mount 102 may further comprise a support plate 258 coupled to the main body 106, e.g., via welding, that may at least partially surround a portion of the main body 106 adjacent to the notch 106-1. Fasteners 118 extend through apertures 255 formed in the retention plate 254 and are received in threaded apertures 259 formed in the support plate 258 to secure the retention plate 254 to the main body 106 of the base mount 102 via the support plate 258. Fasteners 119 extend through apertures 257 (only two of the apertures 257 are labeled in FIG. 2) formed in the retention plate 254 and are received in threaded apertures 117A, 117B formed in the first and second brackets 116A, 116B (only one of the threaded apertures 117A, 117B is labeled in FIG. 2) to secure the first and second brackets 116A, 116B to the retention plate 254, such that the bar 38 of the operator's backrest 34 is received in the notches 116A-1, 116B-1 of the first and second brackets 116A, 116B to clamp the bar 38 between the first and second brackets 116A, 116B and the retention plate 254. Washers (not labeled) may be positioned between the fasteners 118, 119 and the retention plate 254. Upon assembly, an upper half (not labeled) of each of the first and second brackets 116A, 116B may extend above the bar 38, and a lower half (not labeled) of each of the first and second brackets 116A, 116B may extend below the bar 38. The wall 50 comprises at least one opening 50-1 through which the lower half of each of the first and second brackets 116A, 116B extends for coupling to the retention plate 254. When the first and second brackets 116A, 116B are coupled to the retention plate 254, the first and second brackets 116A, 116B may engage, i.e., physically contact, the retention plate 254.

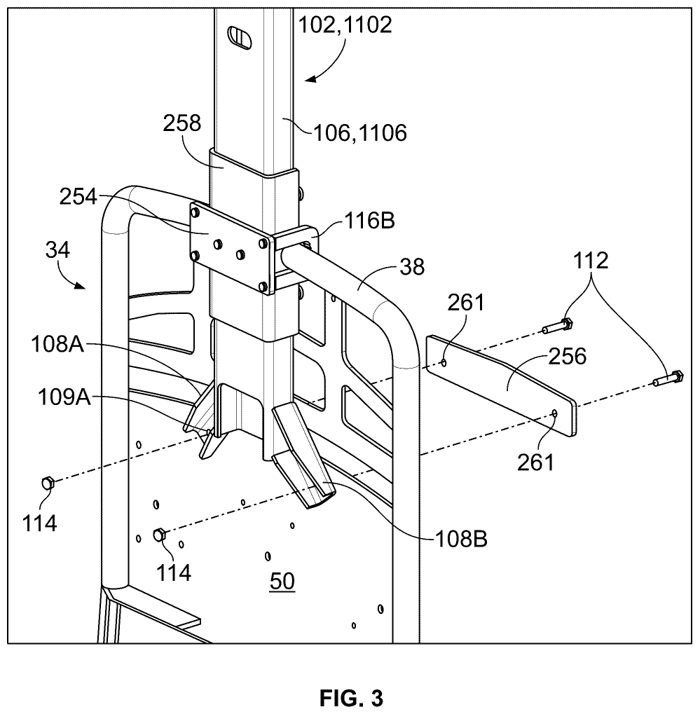

With reference to FIG. 3, a doubler plate 256 is positioned opposite the first and second flanges 108A, 108B. Fasteners 112 extend through apertures 261 formed in the doubler plate 256, through apertures (not visible) formed in the wall 50 of the operator's backrest 34, and through respective apertures 109A formed in the first and second flanges 108A, 108B (only the aperture 109A in the first flange 108A is visible in FIG. 3) and may be secured, e.g., via nuts 114.

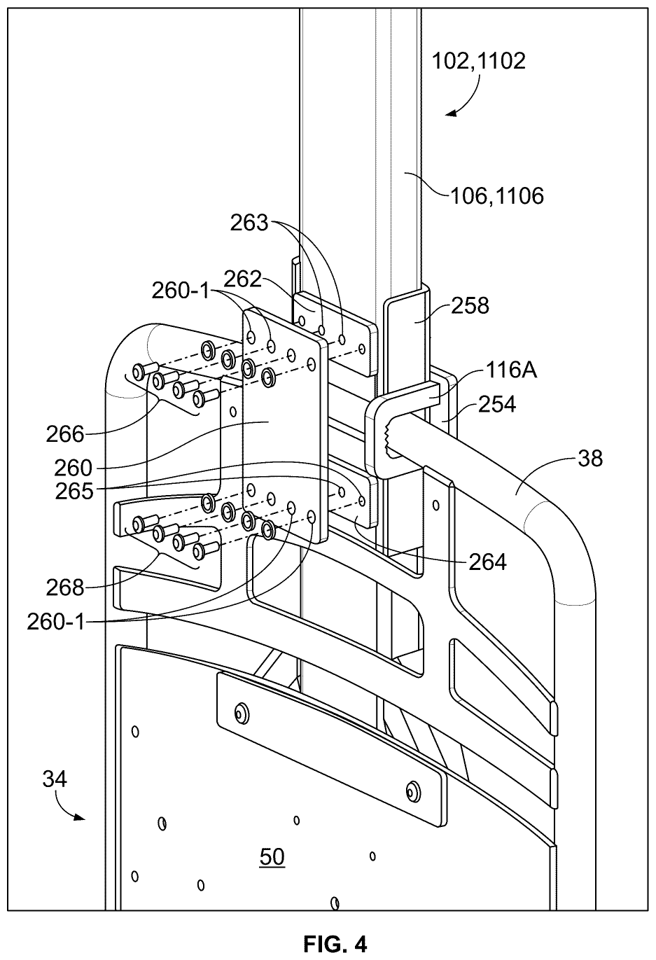

As shown in FIG. 4, a splice plate 260 may be secured to the main body 106 of the base mount 102 between the first and second brackets 116A, 116B on a side of the main body 106 opposite the retention plate 254. The main body 106 may comprise additional support plates 262, 264 coupled thereto, e.g., via welding, and positioned above and below the notch 106-1 (not visible in FIG. 4; see FIG. 2). Fasteners 266, 268 may extend through apertures 261 formed in the splice plate 260 (only four of the apertures 261 are labeled in FIG. 4) and be received in corresponding threaded apertures 263, 265 formed in the additional support plates 262, 264 (only two of the threaded apertures 263 are labeled in FIG. 4 and only two of the threaded apertures 265 are visible in FIG. 4). Washers (not labeled) may be positioned between the fasteners 266, 268 and the splice plate 260.

Upon coupling of the first and second brackets 116A, 116B to the retention plate 254 about the bar 38, coupling of the splice plate 260 to the main body 106, and coupling of the doubler plate 256 to the first and second flanges 108A, 108B through the wall 50 of the operator's backrest 34, the base mount 102 is fixed to the operator's backrest 34, and the base mount 102, specifically the main body 106, extends generally vertically above the operator's platform 32, as shown in FIG. 1. The first and second brackets 116A, 116B, the first and second flanges 108A, 108B, the doubler plate 256, and the splice plate 260 help to stabilize the base mount 102 and secure the base mount 102 to the operator's backrest 34 and also help to stabilize the upper boom portion 104. The boom assembly 100 may be field installable and may be configured for retrofitting to the operator's backrest 34 of existing trucks via the first and second brackets 116A, 116B and the first and second flanges 108A, 108B, as shown in FIGS. 2-4.

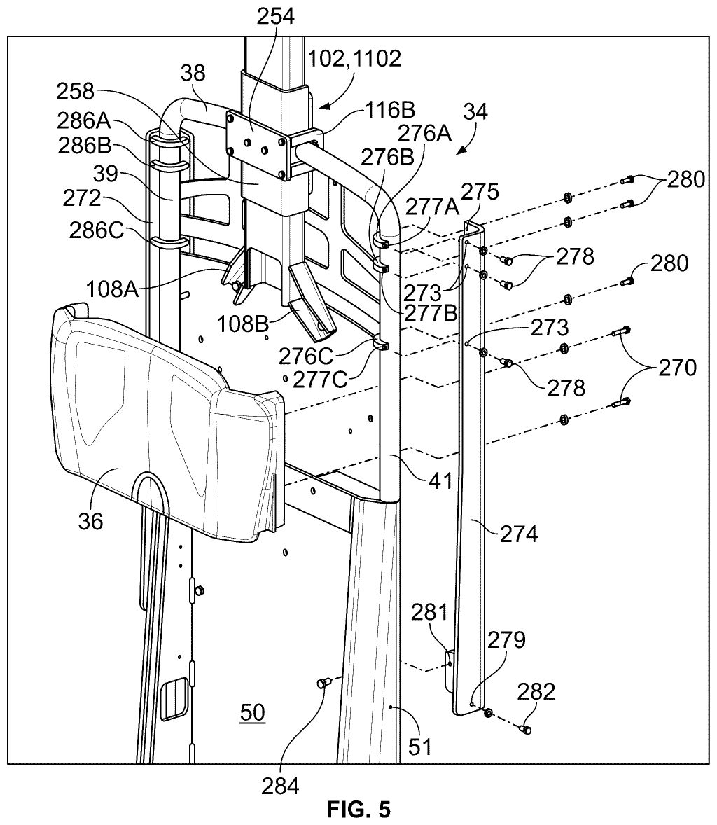

With reference to FIGS. 5 and 6, a pair of braces 272, 274 may be added to help support and strengthen the operator's backrest 34. The operator's backrest 34 may comprise a pair of posts 39, 41 that are coupled to the bar 38 defining the upper portion of the backrest 34, with the bar 38 extending generally horizontally between the posts 39, 41. One of the braces 272 may be attached to one of the posts 39, and the other brace 274 may be attached to the other post 41. With reference to the brace 274, a plurality of brackets 276A, 276B, 276C may be used to attach the brace 274 to the post 41. The brace 274 may comprise an “L” shape, and the brackets 276A, 276B, 276C may comprise a quadrant or quarter-circular shape that fits around the post 41. Fasteners 278 extend through apertures 273 formed along one edge of an upper portion of the brace 274 and are received in corresponding threaded apertures 277A, 277B, 277C formed in one end of the brackets 276A, 276B, 276C. Fasteners 280 extend through apertures 275 (only one aperture 275 is visible in FIG. 5) formed along the other edge of the upper portion of the brace 274 and are received in corresponding threaded apertures (not visible) formed in the other end (not visible) of the brackets 276A, 276B, 276C. A plurality of brackets 286A, 286B, 286C may similarly be used to attach an upper portion of the brace 272 to the post 39.

The braces 272, 274 may extend beyond their respective post 39, 41 and along a lower portion of the wall 50, as shown in FIGS. 5 and 6. With reference to the brace 274 in FIG. 5, one or more fasteners 282 extend through one or more additional apertures 279 formed along one edge of a lower portion of the brace 274 and are received in corresponding threaded aperture(s) 51 formed in the wall 50. One or more fasteners 284 extend through one or more additional apertures (not visible) formed in the wall 50 and are received in corresponding threaded aperture(s) 281 formed along the other edge of the lower portion of the brace 274. A lower portion of the brace 272 may be attached to the wall 50 in a similar manner.

The support pad 36 may be coupled to the operator's backrest 34 via a plurality of fasteners 270 (only two fasteners 270 are shown in FIG. 5) that extend through apertures (not visible) formed in the wall 50 and are received in threaded apertures formed in one or more metal plates (not visible) embedded within a polymeric pad portion of the support pad 36. Although the support pad 36 is depicted as being coupled to the operator's backrest 34 after attachment of the base mount 102 and/or the braces 272, 274, the support pad 36 may also be coupled to the backrest 34 prior to, or at the same time as, attachment of the base mount 102 and/or the braces 272, 274.

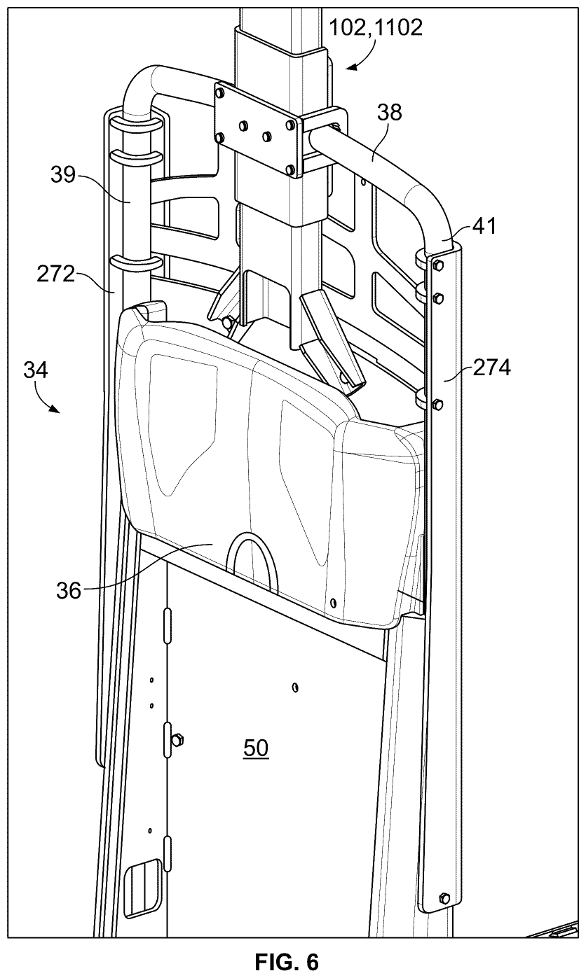

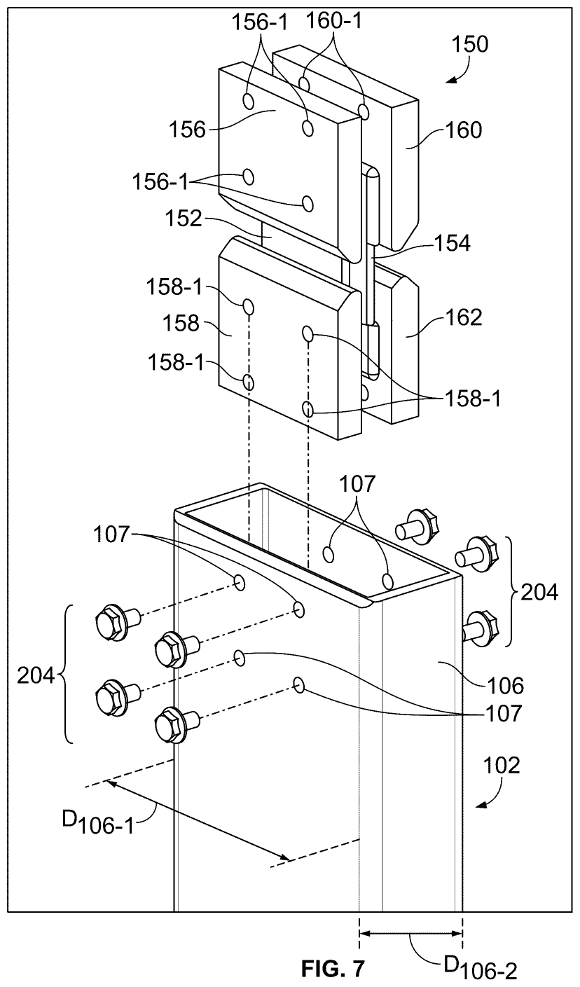

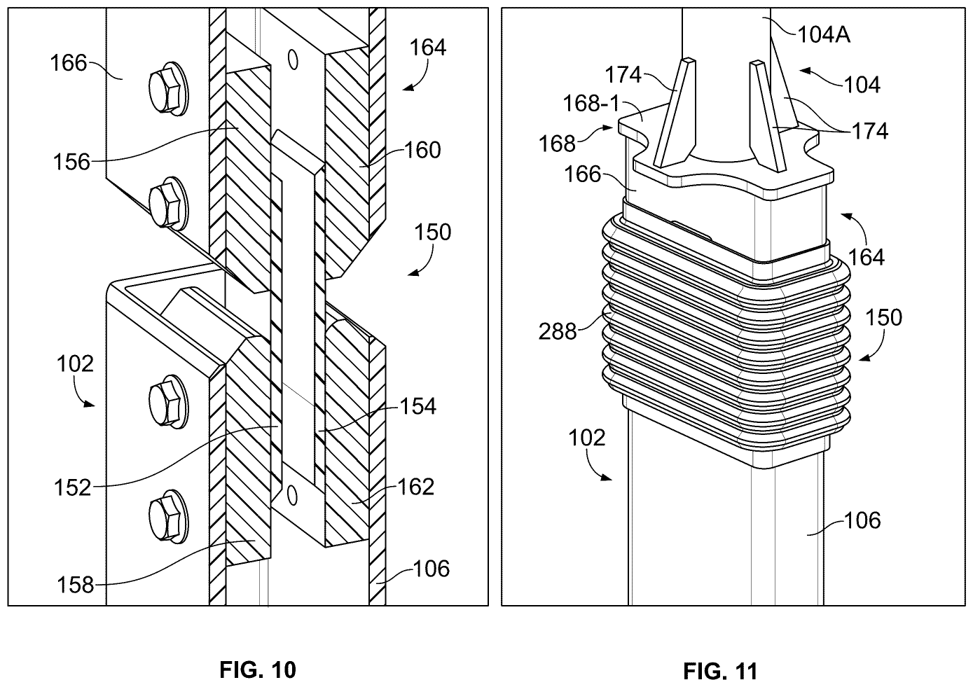

With reference to FIGS. 7-11, an exemplary adapter 150 coupling the base mount 102 to the upper boom portion 104 is described in detail. The adapter 150 comprises at least one coupling member that includes at least one coupling plate. In the example shown, the adapter 150 comprises a first upper plate mount 156, a first lower plate mount 158, a second upper plate mount 160, and a second lower plate mount 162, and the at least one coupling member comprises a first coupling plate 152 and a second coupling plate 154. The first coupling plate 152 is joined to the first upper and lower plate mounts 156, 158, e.g., via welding. The first upper plate mount 156 is coupled to the upper boom portion 104, and the first lower plate mount 158 is coupled to the base mount 102, as described herein. The second coupling plate 154 is similarly joined to the second upper and lower plate mounts 160, 162, e.g., via welding. The second upper plate mount 160 is coupled to the upper boom portion 104, and the second lower plate mount 162 is coupled to the base mount 102, as described herein. Although two coupling plates 152, 154 are shown, it should be understood that the at least one coupling member may include a single coupling plate, e.g., one of coupling plates 152 or 154.

As shown in FIG. 7, the main body 106 of the base mount 102 comprises a plurality of apertures 107 formed on front and back sides. In the example shown, the front side of the main body 106 comprises four apertures 107. The back side of the main body 106 also comprises four apertures 107, although only some of the apertures 107 are visible. The first and second lower plate mounts 158, 162 each comprises a plurality of corresponding threaded apertures 158-1 (only the apertures 158-1 formed in the first lower plate mount 158 are visible in FIG. 7). The first and second lower plate mounts 158, 162 may be configured, i.e., sized and shaped, to fit and be received inside the main body 106 of the base mount 102. To secure the adapter 150, specifically the first and second lower plate mounts 158, 162 and the first and second coupling plates 152, 154 joined thereto, to the main body 106 of the base mount 102, the first and second lower plate mounts 158, 162 may be inserted into the base mount 102 so that the first and second lower plate mounts 158, 162 are received in the main body 106, and the apertures 158-1 formed in the first and second lower plate mounts 158, 162 are aligned with the apertures 107 formed in the main body 106. Fasteners 204 extend through the apertures 107 formed in the front side of the main body 106 and are received in the apertures 158-1 formed in the first lower plate mount 158. Fasteners 204 similarly extend through the apertures 107 formed in the back side of the main body 106 and are received in the apertures (not visible) formed in the second lower plate mount 162.

With reference to FIGS. 1 and 27, the upper boom portion 104 may be coupled to the adapter 150. In the example shown, the upper boom portion 104 is hollow and comprises a first section 104A and a second section 104B. In some examples, the second section 104B extends at an angle with respect to the first section 104A. In the example shown in FIGS. 1 and 27, the second section 104B extends substantially perpendicular, i.e., at an angle of about 90 degrees, +/−5 degrees, with respect to the first section 104A. In other examples (not shown), the second section 104B may extend at an angle of +/−45 degrees from horizontal, e.g., parallel to a plane (not shown) defined by the operator's platform 32 and/or the forks 16. In further examples (not shown), the upper boom portion 104 may comprise a single section that extends generally vertically above the operator's platform 32. In the example shown in FIGS. 1 and 27, a length L₁ of the first section 104A may be different from, e.g., greater than, a length L₂ of the second section 104B. In other examples (not shown), the lengths L₁, L₂ of the first and second sections 104A, 104B may be substantially equal. As shown in FIG. 7, the main body 106 may have a square or rectangular cross section with a first dimension D₁₀₆₋₁ ranging from ½ inch to 6.0 inches and a second dimension D₁₀₆₋₂ ranging from ½ inch to 6.0 inches, and the upper boom portion 104 may have a circular cross section with a diameter dimension ranging from 1.0 inch to 3.0 inches. The main body 106 and the upper boom portion 104 may be made from any metal, such as a steel, stainless steel, aluminum, etc. The main body 106 may have a wall thickness ranging from ⅛ inch to ¼ inch, and the upper boom portion 104 may have a wall thickness ranging from 1/10 inch to ¼ inch. An overall height of the boom assembly 100, i.e., the overall height of the boom assembly 100 above the forks 16 when the boom assembly 100 is installed, may range from 5.5 feet to 14 feet.

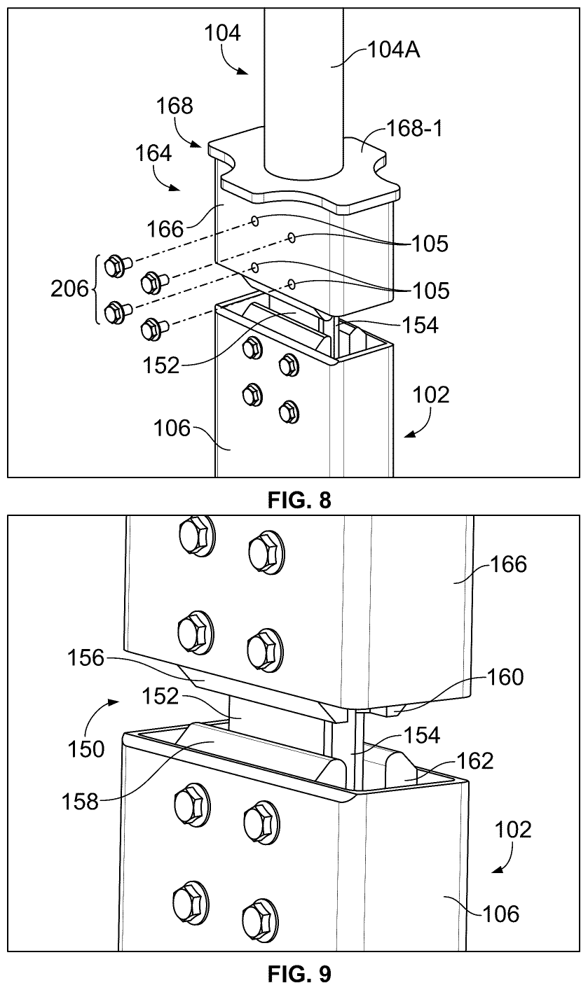

In the example shown in FIGS. 7-11, the upper boom portion 104 comprises a different cross-section, i.e., a generally circular cross-section, as compared to the main body 106 of the base mount 102, and a connector 164 provides a transition between the generally rectangular cross-section of the main body 106 to the generally circular cross-section of the upper boom portion 104. In other examples (not shown), the base mount 102 and the upper boom portion 104 may comprise the same cross-sectional shape. The connector 164 may be positioned between the adapter 150 and the upper boom portion 104, as shown in FIG. 8. The connector 164 comprises a lower element 166 having a cross-sectional shape (i.e., generally rectangular) and dimensions that mirror the cross-sectional shape and dimensions of the main body 106 of the base mount 102. The lower element 166 is coupled, e.g., via welding, to a lower surface (not visible) of an adapter plate 168, and the first section 104A of the upper boom portion 104 is coupled, e.g., via welding, to an upper surface 168-1 of the adapter plate 168 opposite the lower surface. Gussets 174 may be coupled, e.g., via welding, to the first section 104A of the upper boom portion 104 and may be further coupled, e.g., via welding, to the upper surface 168-1 of the adapter plate 168. The gussets 174 may help to attach the first section 104A of the upper boom portion 104 to the adapter plate 168 and to stabilize the upper boom portion 104.

As shown in FIGS. 7 and 8, the lower element 166 of the connector 164 comprises a plurality of apertures 105 formed on front and back sides, and the first and second upper plate mounts 156, 160 each comprises a plurality of corresponding threaded apertures 156-1, 160-1. In the illustrated example, the front side of the lower element 166 comprises four apertures 105. Although not visible, the back side of the lower element 166 also comprises four apertures. The first and second upper plate mounts 156, 160 each comprise four apertures 156-1, 160-1 (only two of the apertures 160-1 formed in the second upper plate mount 160 are visible in FIG. 7).

The first and second upper plate mounts 156, 160 may be configured, i.e., sized and shaped, to fit and be received inside the lower element 166 of the connector 164. To secure the upper boom portion 104 to the adapter 150, specifically to the first and second upper plate mounts 156, 160 and the first and second coupling plates 152, 154 joined thereto, the lower element 166 of the connector 164 may be placed over the first and second upper plate mounts 156, 160 and positioned so that the first and second upper plate mounts 156, 160 are received in the lower element 166 and the apertures 156-1, 160-1 formed in the first and second upper plate mounts 156, 160 are aligned with the apertures 105 formed in the lower element 166. Fasteners 206 extend through the apertures 105 formed in the front side of the lower element 166 and are received in the apertures 156-1 formed in the first upper plate mount 156. Although not visible in FIGS. 7 and 8, fasteners 206 similarly extend through apertures formed in the back side of the lower element 166 and are received in the apertures 160-1 formed in the second upper plate mount 160.

In the example shown in FIGS. 1, 8, and 27, upon coupling of the upper boom portion 104 to the adapter 150 and when the adapter 150 is in a normal operating position (i.e., prior to failure as described herein), the first section 104A of the upper boom portion 104 extends generally vertically above the operator's platform 32 and is generally vertically aligned with the main body 106 of the base mount 102, e.g., aligned along a vertical axis v. The second section 104B of the upper boom portion 104 may extend over, and generally parallel to, the forks 16 and perpendicular to the first section 104A and the main body 106 of the base mount 102. The first and second coupling plates 152, 154 may extend generally vertically and may be generally parallel to the main body 106 of the base mount 102. As shown in FIGS. 1 and 11, a cover 288 may optionally be placed over the adapter 150 and may extend from the lower element 166 of the connector 164 to the main body 106 of the base mount 102 to cover the first and second coupling plates 152, 154. The cover 288 may be formed from a flexible, polymeric material.

With reference to FIGS. 1, 25, and 26, the accessory 300 may be coupled to a distal end 104-1 of the upper boom portion 104 prior to, or after, coupling of the upper boom portion 104 to the adapter 150. In the example shown, the accessory 300 is coupled to the upper boom portion 104 via an adapter bracket 302. In other examples (not shown) the accessory 300 may be coupled to the upper boom portion 104 via a threaded opening in the upper boom portion 104 that receives the accessory 300 or other suitable attachment means. In some examples, the accessory 300 may be wireless and may comprise a battery or other power source. In other examples, wiring (not shown) may extend from the truck 10 through the boom assembly 100 to the accessory 300, e.g., to provide the accessory 300 with power and/or to send data to and receive data from the accessory 300.

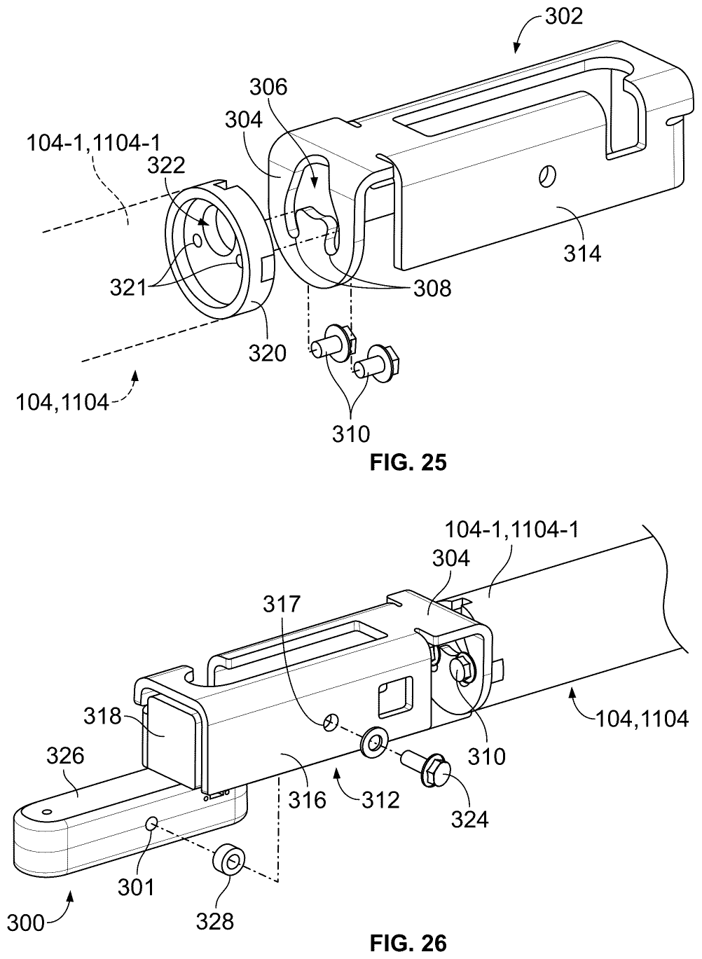

With reference to FIGS. 25 and 26 (an outline of the upper boom portion 104 is shown with dashed lines in FIG. 25 to illustrate internal components), the distal end 104-1 of the upper boom portion 104 may comprise a receiver 320 that is configured to secure the adapter bracket 302 to the upper boom portion 104. The adapter bracket 302 comprises a flange 304 that is seated against the receiver 320 when the adapter bracket 302 is installed. An opening 306 in the flange 304 includes slots 308 through which fasteners 310 extend and are received in threaded apertures 321 formed in the receiver 320. The receiver 320 may comprise an opening 322, such that any wiring (not shown) may extend from the truck 10 through the boom assembly 100 and through the openings 322, 306 to the accessory 300.

After the adapter bracket 302 is coupled to the distal end 104-1 of the upper boom portion 104, the accessory 300 may be coupled to the adapter bracket 302. The adapter bracket 302 comprises a compartment 312 that is defined by the flange 304, side walls 314, 316, and an end wall 318. One of the side walls 316 comprises an opening 317 through which a fastener 324 extends and is received in a threaded aperture 301 formed in a housing 326 of the accessory 300. A washer (not labeled) may be positioned between the fastener 324 and the side wall 316. A spacer 328 may be placed between the accessory 300 and an inner surface (not visible) of the side wall 316 to maintain a desired positioning of the accessory 300 within the compartment 312 and to prevent the accessory 300 from moving during operation. After the accessory 300 is coupled to the adapter bracket 302, the accessory 300 is received in the compartment 312, and the flange 304, side walls 314, 316, and end wall 318 at least partially enclose and protect the accessory 300.

As shown in FIG. 27, the length L₁ of the first section 104A of the upper boom portion 104 and/or a length L₃ of the main body 106 of the base mount 102 may be adjusted or configured as desired to place the accessory 300 at a desired vertical distance D₁ above the forks 16 so that the accessory 300 may perform the desired functions without interfering with the operator or loading of items on the forks 16. The length L₂ of the second section 104B of the upper boom portion 104 may also be adjusted or configured as desired to obtain a desired horizontal placement or positioning of the accessory 300, i.e., a distance D₂ between the operator's backrest 34 or the load backrest 20 and the accessory 300. In particular, the location of the main body 106 and the upper boom portion 104 and/or the length L₂ of the second section 104B may be configured to position the accessory 300: (i) generally centered over the forks 16, (ii) laterally along axis c so as to be near or directly over one of the forks 16, and/or (iii) outside of the load handling/fork area. In some examples, the accessory 300 may be a camera. A pallet (not shown) may be placed on the forks 16, and the boom assembly 100 may position the camera above and over the forks 16 so that the camera may monitor and track items that are loaded onto the pallet. In other examples, the accessory 300 may be an image projecting device, and the boom assembly 100 may position the image projecting device above and over the forks 16 so that the device may project an image at a desired location on the forks 16 or a pallet placed on the forks 16.

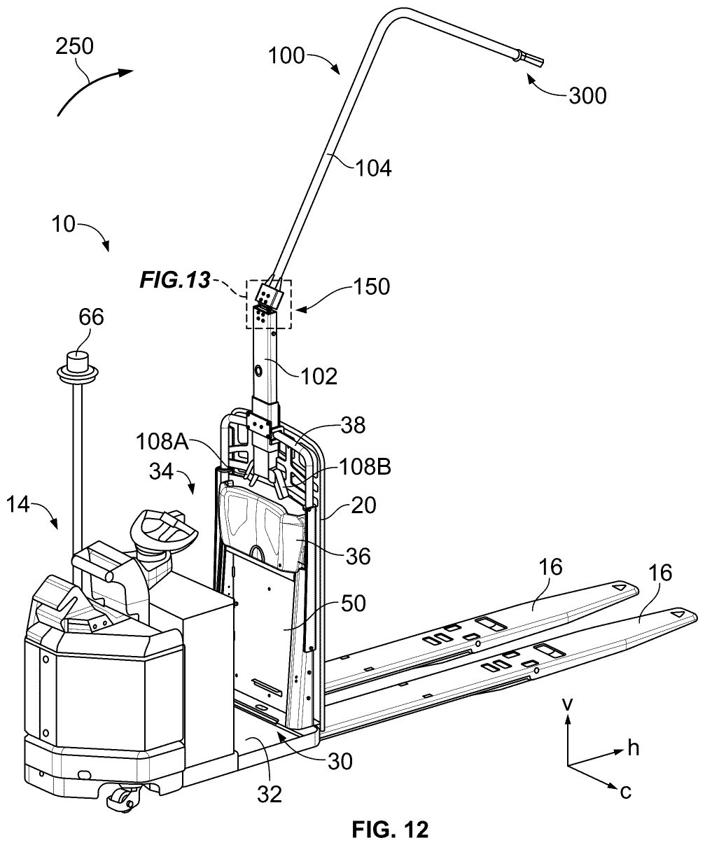

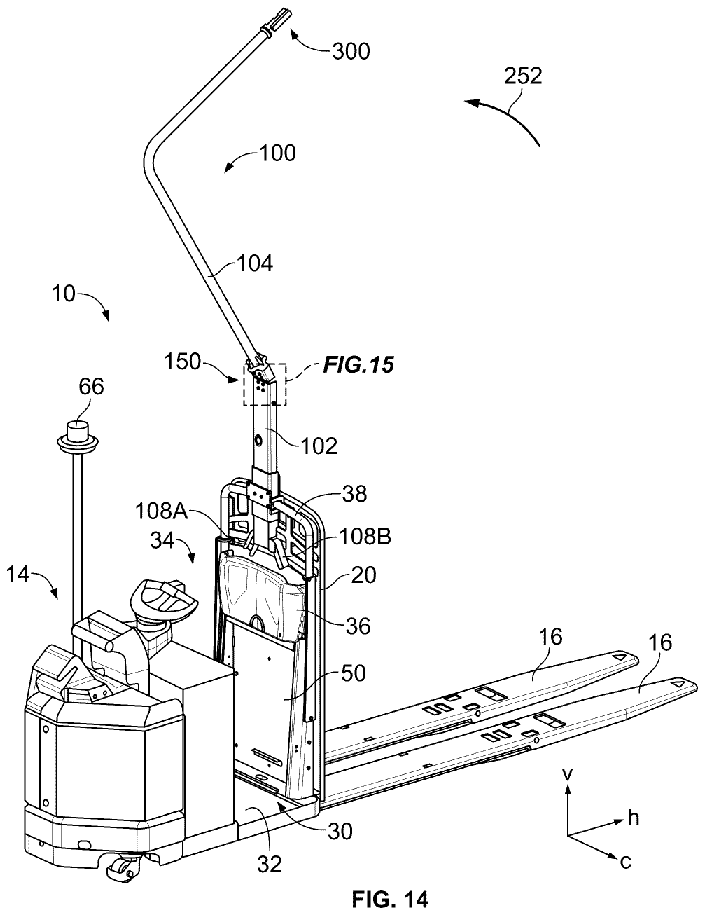

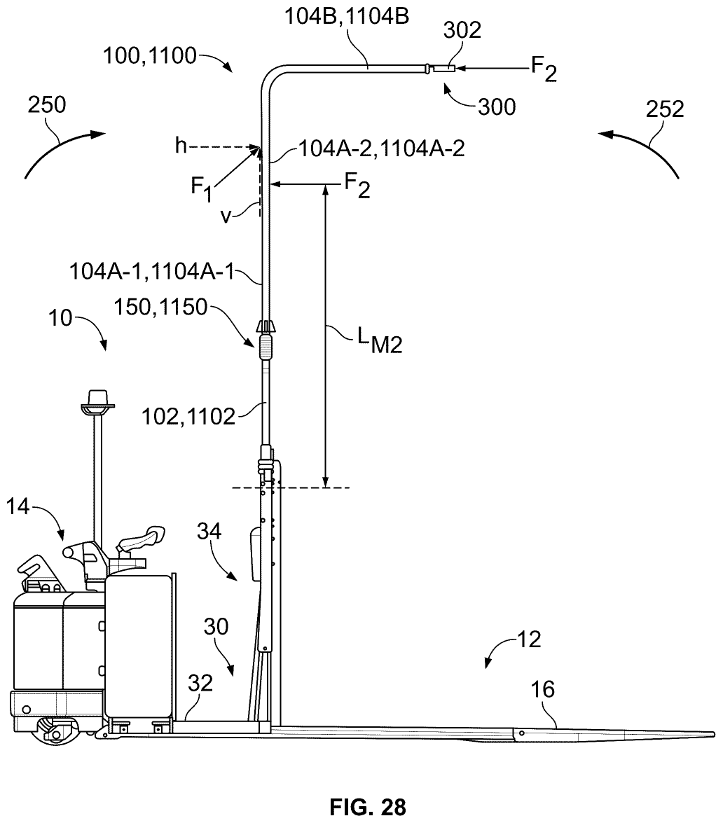

Because the boom assembly 100 may extend generally vertically above the operator's platform 32 and generally horizontally over the forks 16, the boom assembly 100 is subjected to a variety of standard application forces during normal operation of the truck 10, including acceleration, braking, turning, and loading/unloading. The boom assembly 100 may be subjected to additional forces, such as when the boom assembly 100 collides with an object (e.g., an overhead object, a falling object, etc. (not shown)) and/or the truck 10 collides with another object, such as another truck, a rack, etc. (not shown). With reference to FIG. 28, when the upper boom portion 104 collides with an object, the boom assembly 100 may be subjected to forces directly incident on the upper boom portion 104 at any angle, such as exemplary external force F₁ or force F₂. The external forces F₁, F₂ may have force components coincident or parallel with a horizontal axis h, a vertical axis v, and/or an out-of-plane axis c, which axes are shown in FIGS. 12 and 14.

For example, as shown in FIG. 28, the external force F₁ may be caused by an object engaging/striking a first wall 104A-1 of the first section 104A of the upper boom portion 104, which first wall 104A-1 faces away from the forks 16. The force F₁ may strike the first wall 104A-1 at an angle, such that the force F₁ may have horizontal and vertical force components, as indicated by line h and line v, respectively. This force F₁ may cause the boom assembly 100 to bend in a bending direction 250 toward the forks 16 (also referred to herein as a first bending direction; see also FIG. 12). Alternatively, with continued reference to FIG. 28, the upper boom portion 104 may be subjected to a different external force, such as the force F₂, caused by an object acting on a second wall 104A-2 of the first section 104A of the upper boom portion 104, which second wall 104A-2 faces toward the forks 16, and/or acting on the adapter bracket 302, e.g., on the end wall 318 (see FIG. 26) of the adapter bracket 302 that extends substantially parallel to the second wall 104A-2. The force F₂ may comprise a normal force acting on the second wall 104A-2 of the first section 104A of the upper boom portion 104 or on the adapter bracket 302. This force F₂ may cause the boom assembly 100 to bend in a bending direction 252 toward the power unit 14 (also referred to herein as a second direction; see also FIG. 14).

Without the adapter 150 in accordance with the present disclosure, these external forces F₁ or F₂ may generate stresses on the boom assembly 100, the operator's backrest 34, and other components of the truck 10 that may cause damage or failure in structural integrity, such as permanent deformation, cracking, shearing, or other type(s) of failure. As shown in FIGS. 1, 9, and 28, the adapter 150 is configured to maintain the boom assembly 100 in a normal (e.g., upright) operating position when the upper boom portion 104 is subjected to standard application forces during normal operation of the truck 10, i.e., when the upper boom portion 104 is subjected to one or more external forces causing one or more internal stresses in the first and second coupling plates 152, 154 that are below the yield stress threshold of the first and second coupling plates 152, 154. The adapter 150 is further configured to yield or fail in a controlled manner, as shown in FIGS. 12-15, when the upper boom portion 104 is subjected to one or more external forces causing one or more internal stresses in the first and second coupling plates 152, 154 equal to, or in excess of, the yield stress threshold of the first and second coupling plates 152, 154. The yield stress threshold of the first and second coupling plates 152, 154 may be designed so that the adapter 150 yields or fails before one or more external forces applied to the upper boom portion 104 cause stresses in the operator's backrest 34 sufficient to result in damage or failure in the structural integrity of the operator's backrest 34. Hence, the yield stress threshold of the first and second coupling plates 152, 154 may be designed so that the adapter 150 yields or fails before the one or more external forces applied to the upper boom portion 104 cause an element or component of the truck 10, i.e., the operator's backrest 34, to which the boom assembly 100 is coupled, to fail. The boom assembly 100 is considered to comprise the structure, i.e., the first and second brackets 116A, 116B and the first and second flanges 108A, 108B, for coupling the base mount 102 to the truck 10.

When a force, such as exemplary force F₂ illustrated in FIG. 28, acts on the second wall 104A-2, a moment M₂₀₀ of the force F₂ equals a magnitude of the force F₂ (i.e., its component parallel to the horizontal axis h; see FIG. 1) times a length L_{M2} extending from where the force F₂ impacts or is applied to the second wall 104A-2 to a location anywhere on the operator's backrest 34 (as the base mount 102 is coupled to the operator's backrest 34), such as where the first and second flanges 108A, 108B (not visible in FIG. 28; see FIGS. 2 and 3) are coupled to the operator's backrest 34. The operator's backrest 34 will experience substantial bending stress from the moment M₂₀₀. A geometry of, and material used for, the main body 106 of the base mount 102 and upper boom portion 104 are generally selected so that the main body 106 and the upper boom portion 104 have a high section modulus to withstand impact forces. Hence, when a force, such as force F₂, acts on the boom assembly 100, stresses on the boom assembly 100 and the operator's backrest 34 resulting from the force F₂ and its corresponding moment M₂₀₀ are more likely to cause damage to the structural integrity of the operator's backrest 34 than the boom assembly 100. Accordingly, a yield stress threshold for failure of the operator's backrest 34 will be determined, which may be used to determine a yield stress threshold for each of the first and second coupling plates 152, 154 of the adapter 150 (the first and second coupling plates 152, 154 are not visible in FIG. 28; see FIG. 9).

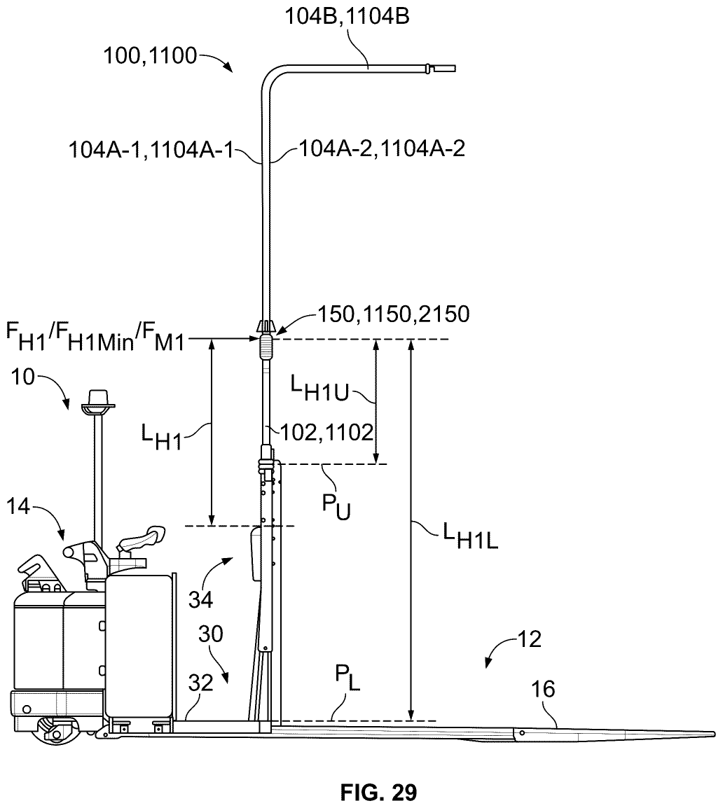

With reference to FIG. 29, it is presumed that a force F_{H1} is applied at a height above the forks 16 and the operator's platform 32, which height is slightly above an operator height H₂ for a 95^{th} percentile adult male, see FIG. 27. An internal moment M_{H1} from the force F_{H1} is developed within the operator's backrest 34, which equals a magnitude of the force F_{H1} (i.e., its component parallel to the horizontal axis h) times a length L_{H1} extending from where the force F_{H1} impacts or is applied to the upper boom portion 104 to a given location on the operator's backrest 34, which given location on the operator's backrest 34 may extend from a lowermost point P_{L} on the operator's backrest 34 to an uppermost point Pu on the operator's backrest 34, see FIG. 29.

A bending stress at the operator's backrest 34 resulting from moment M_{H1} is given by the following Equation (1):

σ=M_{H1}/Z
where σ=bending stress; M_{H1}=moment; and
Z=section modulus based on a geometry of the operator's backrest 34.

Equation (1) may be solved for various values of moment M_{H1i}, in which i=1 . . . n, in which each moment M_{H1i} has a corresponding moment arm defined by a length L_{H1i}, in which i=1 . . . n, in which L_{H1i} may be any length extending from where the force F_{H1} impacts or is applied to the upper boom portion 104 to an end point at or between the lowermost point P_{L} of the operator's backrest 34 (illustrated as L_{H1L} in FIG. 29) and the uppermost point Pu of the operator's backrest 34 (illustrated as L_{H1U} in FIG. 29). Bending stress a may be set equal to a yield strength of the material from which the operator's backrest 34 is formed, such as a specific grade of steel from which the operator's backrest 34 is formed. Yield strengths for such materials are well known. The section modulus Z can be calculated from the geometry of the operator's backrest 34 and may vary with height depending on backrest geometry, as section modulus Z may change along a height of the operator's backrest 34, i.e., a section modulus Z calculated for a backrest horizontal plane taken at one point along the height of the operator's backrest 34 may vary from a section modulus Z calculated for a backrest horizontal plane taken at a different point along the height of the operator's backrest 34. That is, the section modulus Z may have one value when the moment arm defined by the length L_{H1L} has an end point positioned at the lowermost point P_{L} of the operator's backrest 34, as the cross-section of the geometry at the lowermost point P_{L} of the operator's backrest 34 will be used when calculating the section modulus Z, and the section modulus Z may have another value when the moment arm defined by the length L_{H1u} has an end point positioned at the uppermost point Pu of the operator's backrest 34, as the cross-section of the geometry at the uppermost point Pu of the operator's backrest 34 will be used when calculating the section modulus Z, which may differ from the cross-section taken at the lowermost point P_{L} of the operator's backrest 34. Setting the bending stress a equal to the yield strength of the material from which the operator's backrest 34 is formed allows a moment M_{H}ii at each determined section modulus Z to be calculated that would result in the structural integrity of the operator's backrest 34 being damaged, see Equation (1) above. Each section modulus Z may be located at a different height along the operator's backrest 34 such that each calculated moment M_{M1i} with a different, corresponding section modulus Z may have a different moment arm or length L_{H1i}. The yield strength also defines a yield stress threshold for the operator's backrest 34. In other words, the force F_{H1} resulting in the moment M_{H1} will create stresses in the operator's backrest 34 equal to the yield stress threshold for the operator's backrest 34, resulting in structural integrity damage to the operator's backrest 34.

The moment M_{H1i} having the lowest value from all values of the moment M_{H1i} calculated, which equals the smallest moment M_{Hl1} to cause damage to the operator's backrest 34, is designated as a minimum moment value M_{H1Min}. Once the minimum moment M_{H1Min} is known, a magnitude of a corresponding force F_{H1Min} may be determined, which force F_{H1Min} is likely to cause structural integrity damage to the operator's backrest 34. The force F_{H1Min} may be determined by dividing the moment M_{H1Min} by a length corresponding to moment M_{H1Min}, e.g., the length corresponding to the section modulus Z corresponding to and from which the minimum moment M_{H1Min} was determined. It is desirable to have each of the first and second coupling plates 152, 154 (not shown in FIG. 29; see FIG. 9) fail prior to structural integrity damage occurring at the operator's backrest 34. Hence, the force F_{H1Min} may be multiplied by a safety factor, such as 0.5 or any other value desired to calculate a modified force F_{M1}.

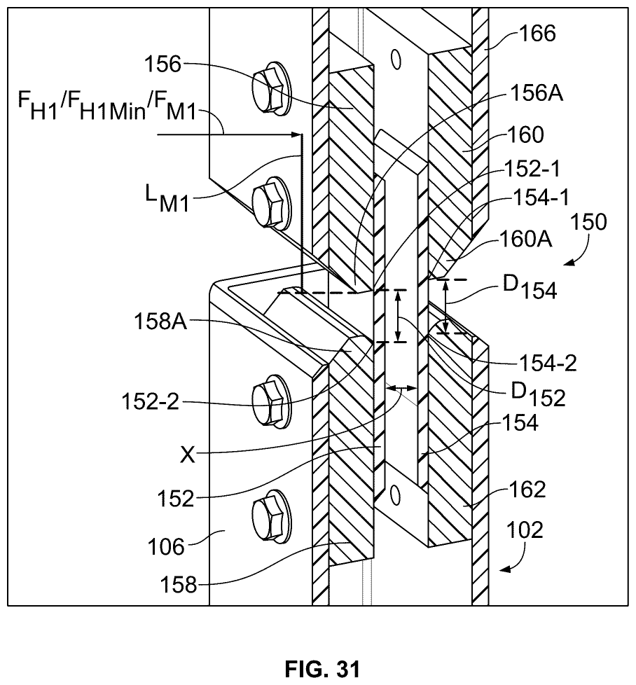

As illustrated in FIGS. 29-31, the force F_{H1Min} may be applied to a section of the upper boom portion 104, specifically to a section of the connector 164, which location where the force F_{H1Min} is applied is spaced a distance from a top of an unsupported coupling plate section, i.e., a respective location 152-1, 154-1 at which the first and second coupling plates 152, 154 extend beyond the first and second upper plate mounts 156, 160, which distance from where the force F_{H1Min} is applied to the respective location 152-1, 154-1 is equal to length L_{M1}. Using the modified force F_{M1} instead of the force F_{H1Min}, a moment M_{FM1} of the modified force F_{M1} about an axis A_{M1} at one of (or at a point midway between) the locations 152-2, 154-2, where the first and second coupling plates 152, 154 and upper end portions 158A, 162A of the first and second lower plate mounts 158, 162 meet equals a magnitude of the modified force F_{M1} (i.e., its component parallel to the horizontal axis h) times the length L_{M1} plus a length D₁₅₂ or D₁₅₄ extending from where the modified force F_{M1} impacts or is applied to the upper boom portion 104/connector 164 to a location on one of (or at a point midway between) the locations 152-2, 154-2.

The moment M_{FM1} corresponding to the modified force F_{M1} may be expressed in the following Equation (2):

$${M}_{F M 1} = {M}_{local} + {M}_{global}$$

$$Where :$$

$${M}_{local} = {F}_{M 1} * D ;$$

$${M}_{global} = {F}_{M 1} * {L}_{M 1} ; and$$

D is the length of an unsupported distance D₁₅₂ of the first coupling plate 152 between the first upper and lower plate mounts 156, 158 or the length of an unsupported distance D₁₅₄ of the second coupling plate 154 between the second upper and lower plate mounts 160, 162. Hence D=D₁₅₂; D=D₁₅₄; and D₁₅₂=D₁₅₄. Length D is selected so that the first and second coupling plates 152, 154 have sufficient length to bend without fracturing or cracking.

L_{M1} is a lever arm distance from the impact force F_{M1} to one of (or a point midway between) the locations 152-1, 154-1, where the first and second coupling plates 152, 154 and lower end portions 156A, 160A of the first and second upper plate mounts 156, 160 meet.

Total stresses σₜₒₜₐₗ occurring within each one of the first and second coupling plates 152, 154 when the modified force F_{M1} impacts on the upper boom portion 104/the connector 164, may be calculated from the following Equation (3):

$${σ}_{total} = {σ}_{axial couple} + {σ}_{local bending} + {σ}_{global bending}$$

$$Where :$$

$${σ}_{axial couple} = \frac{{F}_{M 1} * {L}_{M 1} * ( 1 - D F )}{{A}_{plate} * x}$$

$${σ}_{local} = \frac{{F}_{m 1} * {D}_{}}{2 * Z}$$

$${σ}_{global} = \frac{D F * {F}_{m 1} * {L}_{m 1}}{2 * Z}$$

X is a distance between the first and second coupling plates 152, 154 in a direction parallel to the h axis. Distance X is selected so that the first and second coupling plates 152, 154 do not contact during bending.

L_{M1} is a lever arm distance from the impact force F_{M1} to one of (or a point midway between) the locations 152-1, 154-1.

D is the length of an unsupported distance D₁₅₂ of the first coupling plate 152 between the first upper and lower plate mounts 156, 158 or the length of an unsupported distance D₁₅₄ of the second coupling plate 154 between the second upper and lower plate mounts 160, 162.

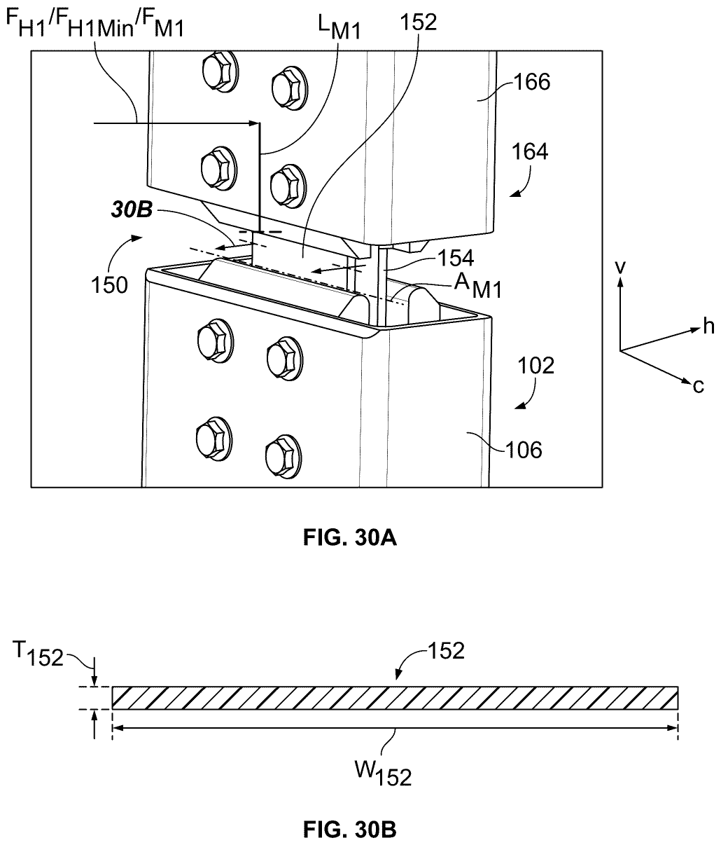

Aₚₗₐₜₑ is the cross-sectional area of each of the first and second coupling plates 152, 154, i.e., determined by multiplying a first dimension T₁₅₂ times a second dimension W₁₅₂, see FIG. 30B, in which only the dimensions T₁₅₂ and W₁₅₂ are illustrated for the first coupling plate 152. However, the second coupling plate 154, in the illustrated embodiment, has the same cross section and, hence, the same dimensions T₁₅₂ and W₁₅₂.

DF=moment distribution factor having a value between 0 and 1 and, in the illustrated embodiment, equals 0.5 since both the first and second coupling plates 152, 154 are identical.

Z=a section modulus for each of the first and second coupling plates 152, 154, which can be determined based on the geometry of each of the first and second coupling plates 152, 154.

The total stresses σₜₒₜₐₗ occurring within each one of the first and second coupling plates 152, 154 when the modified force F_{M1} impacts on the upper boom portion 104/the connector 164 may be set equal to a yield strength of the material from which each of the first and second coupling plates 152, 154 is formed, such as a specific grade of steel. Yield strengths for such materials are well known. When the total stresses σₜₒₜₐₗ occurring in each one of the first and second coupling plates 152, 154 equals the yield strength σ_{yield strength} of the material from which the first and second coupling plate 152, 154 is formed, each of the first and second coupling plates 152, 154 will fail or yield, i.e., permanently deform or bend. The yield strength σ_{yield strength} of the material from which each of the first and second coupling plates 152, 154 is formed is equal to a yield stress threshold for each of the first and second coupling plates 152, 154. Setting total stresses σₜₒₜₐₗ equal to the yield strength σ_{yield strength} of the material from which the first and second coupling plate 152, 154 is formed may be expressed by the following Equation (4):

$${σ}_{yield strength} = {σ}_{total} = {F}_{m 1} * ( \frac{{L}_{m 1} * ( 1 - D F )}{{A}_{p l a t e} * X} + \frac{( {L}_{M 1} * D F + D )}{2 * Z} )$$

For rectangular coupling plates 152, 154, Z may be determined from the following Equation (5).

$$Z = \frac{{T}_{152} * {A}_{plate}}{6}$$

As noted above, the second coupling plate 154, in the illustrated embodiment, has the same cross section as the first coupling plate 152 and, hence, the same dimensions T₁₅₂ and W₁₅₂. Accordingly, Equation (5) may also be used to determine Z for the second coupling plate 154. As noted above, length D is selected so that the first and second coupling plates 152, 154 bend and do not fracture and distance X is selected so that the first and second coupling plates 152, 154 do not contact during bending. As also noted above, the cross-sectional area Aₚₗₐₜₑ of each of the first and second coupling plates 152, 154 may be determined by multiplying the first dimension T₁₅₂ times the second dimension W₁₅₂. As the distance X increases, an overall stiffness of the coupling element (i.e., the first and second coupling plates 152, 154) increases, i.e., an amount of force necessary to bend the first and second coupling plates 152, 154 increases. Hence, various combinations of the first dimension T₁₅₂, the cross-sectional area Aₚₗₐₜₑ (T₁₅₂*W₁₅₂) for each of the first and second coupling plate 152, 154, and the distance X may be substituted into Equations (4) and (5) and appropriate values for the first and second dimensions T₁₅₂ and W₁₅₂ and, hence, the cross-sectional area Aₚₗₐₜₑ and the distance X are selected. Preferably, the cross-sectional area Aₚₗₐₜₑ is selected to be sufficiently large to minimize deflection of the upper boom portion 104 and maximize resiliency to prevent fatigue of the first and second coupling plates 152, 154. Using Equations (4) and (5), each of the first and second coupling plates 152, 154 is designed so that the first and second coupling plate 152, 154 fails when the modified force F_{M1} is applied to the upper boom portion 104/the connector 164 at the location illustrated in FIGS. 29, 30A and 31 or a moment is generated by a force F applied anywhere along the upper boom portion 104 and having a moment arm extending to any location on the backrest 34, in which the moment generated by that force F is equal to or greater than the moment M_{FM1}. Hence, both the first and second coupling plates 152, 154 will fail or yield prior to structural integrity damage occurring at the operator's backrest 34.

Determining the modified force F_{M1} and the corresponding moment M_{FM1} may be found using finite element analysis methods so as to allow the first and second dimensions T₁₅₂ and W₁₅₂ and the cross-sectional area Aₚₗₐₜₑ and the distance X to be calculated from Equations (4) and (5).

It is further contemplated that each of the first and second coupling plates 152, 154 may be designed via experimentation using actual boom assemblies (e.g., by applying one or more external forces to actual boom assemblies to allow each of the first and second coupling plates 152, 154 to be designed so that each of the first and second coupling plates 152, 154 yields or fails prior to structural integrity damage occurring at the operator's backrest 34). Hence, the first and second coupling plates 152, 154 are designed so that when one or more external forces are applied to a boom assembly sufficient to cause internal stresses in each of the first and second coupling plates 152, 154 equal to or in excess of the yield stress threshold of each of the first and second coupling plates 152, 154, each of the first and second coupling plates 152, 154 fails prior to structural integrity damage occurring at the operator's backrest. The first and second coupling plates 152, 154 may also be designed via one or more suitable computer modelling techniques such that each of the first and second coupling plates 152, 154 fails prior to structural integrity damage occurring at the operator's backrest or any other element of the truck 10.

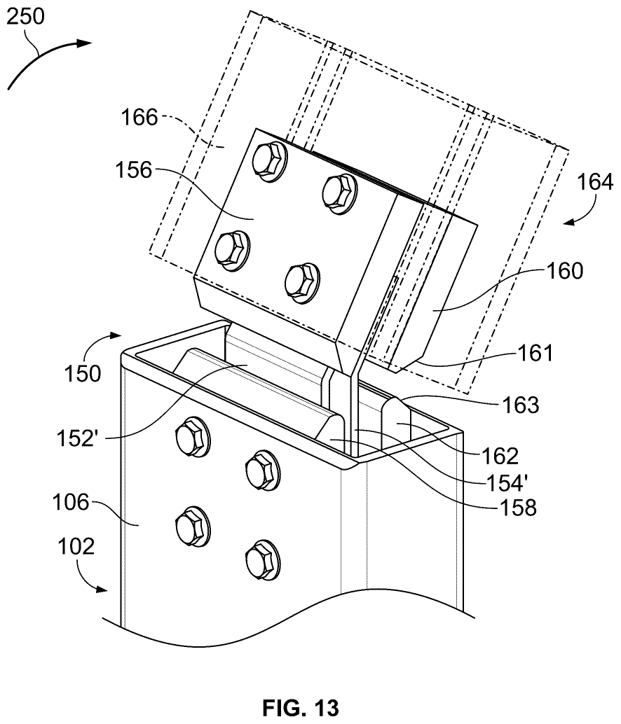

As shown in FIG. 28, the upper boom portion 104 may be subjected to an external impact force, i.e., exemplary force F₁, at an angle to the first wall 104A-1 of the upper boom portion 104 and generally extending toward the forks 16. When a horizontal component of the external force F₁ (indicated by line h) acting on the first wall 104A-1 of the upper boom portion 104 creates internal stresses in the first and second coupling plates 152, 154, equal to or in excess of the yield stress threshold, i.e., the yield strength σ_{yield strength} of the material from which each of the first and second coupling plates 152, 154 is formed, the adapter 150 yields or fails, and the connector 164, along with the upper boom portion 104 coupled thereto, are displaced toward the forks 16 (referred to herein as a first failed state), as shown in FIGS. 12 and 13. In other words, application of the external force F₁ to the upper boom portion 104 causes displacement of the connector 164 in the first bending direction 250, and when the magnitude of the external force F₁ is sufficient to cause internal stresses in each of the first and second coupling plates 152, 154 to equal or exceed the yield stress threshold of the first and second coupling plates 152, 154 (i.e., the external force F₁ on the upper boom portion 104 causes the connector 164 to create stresses in each of the first and second coupling plates 152, 154 equal to or in excess of a yield stress threshold of each first and second coupling plates 152, 154), the first and second coupling plates 152, 154 fail and begin to plastically deform, i.e., bend, in the first bending direction 250, as indicated by bent first and second coupling plates 152′, 154′ in FIG. 13. The first and second coupling plates 152, 154 bend about an axis (not shown) that is parallel to axis c (see FIG. 12).

A yield stress threshold of the adapter 150 may equal the yield stress threshold for each of first and second coupling plates 152, 154, i.e., the yield strength σ_{yield strength} of the material from which each of the first and second coupling plates 152, 154 is formed. Failure and deformation of the first and second coupling plates 152, 154 allows the connector 164, along with the upper boom portion 104 coupled thereto, to rotate or be displaced in the first bending direction 250, i.e., toward the forks 16 (in FIG. 13, the upper boom portion 104 is not shown (see FIG. 28) and the lower element 166 of the connector 164 is shown with dashed lines to illustrate the internal structure of the adapter 150). The first and second coupling plates 152, 154 may be formed from the same material, e.g., a metal such as steel, and may have the same structure/geometry, such that the first and second coupling plates 152, 154 each have the same yield stress threshold. The first and second dimensions T₁₅₂ and W₁₅₂ and the cross-sectional area Aₚₗₐₜₑ of each of the first and second coupling plates 152, 154, the distance X and the material from which each of the first and second coupling plates 152, 154 is formed, which material has a given yield strength σ_{yield strength} defining the yield stress threshold of each of the first and second coupling plates 152, 154, may be selected, such that the first and second coupling plates 152, 154 fail or yield before the one or more external forces applied to the upper boom portion 104 cause damage to, or failure of, the structural integrity of the operator's backrest 34. Thus, the first and second coupling plates 152, 154 act as a moment limiter for the operator's backrest 34 thereby ensuring that the first and second coupling plates 152, 154 fail prior to the backrest 34.

In examples, each of the first and second coupling plates 152, 154 may be formed from steel, have a first dimension T₁₅₂ from about ⅛ inch to about ⅜ inch, a second dimension W₁₅₂ from about 2.0 inches to about 5.0 inches, a cross-sectional area Aₚₗₐₜₑ from about ¼ inch² to about 1.875 inch², a distance X between the first and second coupling plates 152, 154 from about ½ inch to about 2.0 inches, and a length D from about ⅜ inch to about 2.0 inches.

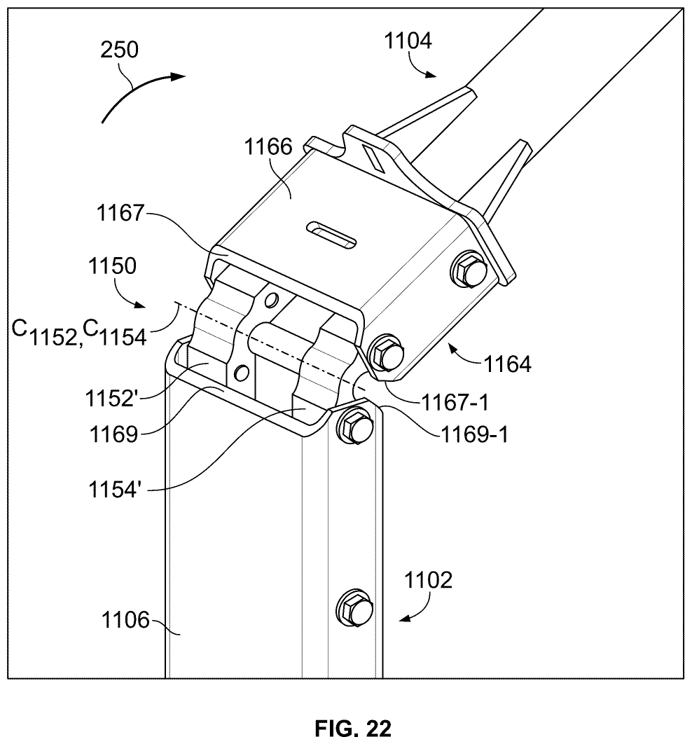

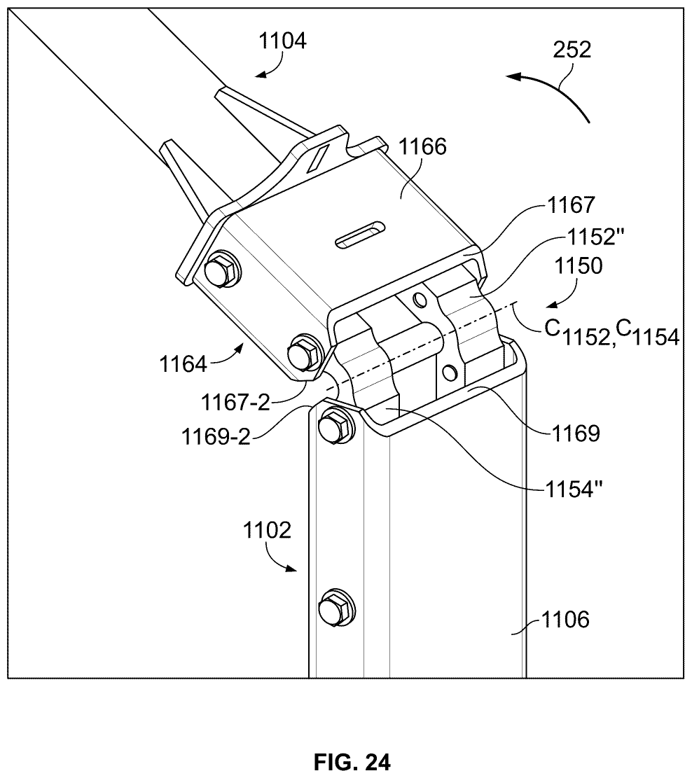

The first and second coupling plates 152, 154 may permanently and plastically deform to allow controlled movement of the upper boom portion 104 to a final deformed angular position relative to the base mount 102, as shown in FIGS. 12 and 13. The second upper and lower plate mounts 160, 162 provide a first stop that limits rotation of the connector 164, and the upper boom portion 104 coupled thereto, in the first bending direction 250. The connector 164 is depicted in FIGS. 12 and 13 as having rotated by about 45 degrees from a normal operating position with respect to the main body 106 of the base mount 102. A lower surface of the second upper plate mount 160 may comprise a sloped or chamfered edge 161, and an upper surface of the second lower plate mount 162 may comprise a corresponding sloped or chamfered edge 163. If the connector 164 continues rotating in the first bending direction 250 beyond about 45 degrees, at 90 degrees, or any angle greater than 45 degrees, the chamfered edge 161 of the second upper plate mount 160 engages the chamfered edge 163 of the second lower plate mount 162, with engagement between the chamfered edges 161, 163 acting as the first stop to halt rotation of the connector 164 beyond about 90 degrees. The first and second coupling plates 152, 154 may also be used with the base mount 1102 and upper boom portion 1104 described in detail with respect to FIGS. 22 and 24, in which a portion of the base mount 1102 and the upper boom portion 1104 form first and second stops.

The first and second coupling plates 152, 154 may resist rotation of the connector 164 in the first bending direction 250 and may absorb at least a portion of the energy resulting from the impact to slow and eventually stop the displacement of the upper boom portion 104. The amount of resistance provided by the first and second coupling plates 152, 154 may be selected based on the shape, geometry, and/or material of the first and second coupling plates 152, 154, as well as the configuration of the first and second coupling plates 152, 154 with respect to each other and/or with respect to the upper and lower plate mounts 156, 160 and 158, 162 (e.g., distances X, D₁₅₂, and D₁₅₄, as described above). The adapter 150 is configured such that upon removal of the one or more external forces, i.e., force F₁, causing the one or more internal stresses in the first and second coupling plates 152, 154 equal to or in excess of the yield stress threshold of the first and second coupling plates 152, 154 resulting in plastic deformation of the first and second coupling plates 152, 154, the plastically deformed first and second coupling plates 152′, 154′ further hold the upper boom portion 104 at the final deformed angular position to prevent free-falling over of the upper boom portion 104. As shown in FIG. 13, the first and second coupling plates 152′, 154′ plastically deform/bend upon failure but typically do not break or fracture, such that the first and second coupling plates 152′, 154′ remain connected/attached to connector 164 and the base mount 102, thereby preventing or minimizing damage to the truck 10, the base mount 102 and the upper boom portion 104, the accessory 300, and/or adjacent personnel or objects. Even at very high magnitudes of the impact force F₁ occurring at the upper boom portion 104, both of the first and second coupling plates 152′, 154′ will remain coupled to the connector 164 and the base mount 102 as the object imparting the impact force F₁ moves over or past the upper boom portion 104, i.e., the adapter 150 is fixedly coupled to the upper boom portion 104 via the connector 164 and the base mount 102 and has sufficient strength to remain coupled to the upper boom portion 104 and the base mount 102, as the first and second coupling plates 152′, 154′ will yield or deflect before the upper and lower plate mounts 156, 160 and 158, 162 and/or the first and second coupling plates 152′, 154′ separate from one another or from the upper boom portion 104 or the base mount 102. Further, the angle of deflection of the first and second coupling plates 152′, 154′ will stabilize at the final deformed angular position once the object imparting the impact force F₁ is no longer in contact with the upper boom portion 104, i.e., the first and second coupling plates 152′, 154′ have sufficient rigidity that the weight of the upper boom portion 104 will have little or no impact on the amount of deformation occurring at the first and second coupling plates 152′, 154′ after the impact force has been removed. Hence, the plastically deformed first and second coupling plates 152′, 154′ hold the upper boom portion 104 at the final deformed angular position in which the first and second coupling plates 152′, 154′ are located when the impact force is removed, i.e., the upper boom portion 104 is held in a fixed position and the first and second coupling plates 152′, 154′ do not further deform or move angularly relative to the base mount 102 after the impact force has been removed and the first and second coupling plates 152′, 154′ have stabilized, thereby preventing free-falling over of the upper boom portion 104.

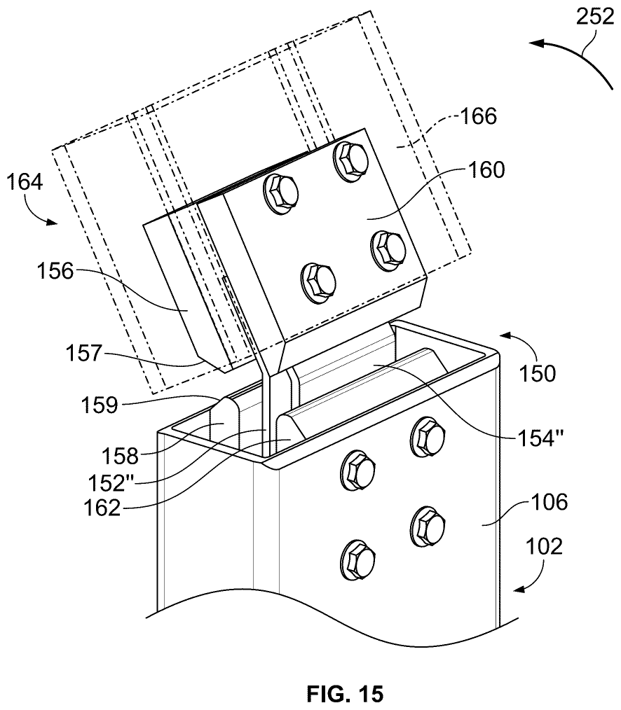

As shown in FIG. 28, the upper boom portion 104 may be subjected to an external impact force, i.e., exemplary force F₂, in a direction generally toward the power unit 14. When the force F₂ acting on the second wall 104A-2 of the upper boom portion 104 creates one or more internal stresses in the first and second coupling plates 152, 154 equal to or in excess of the yield stress threshold of the first and second coupling plates 152, 154, the adapter 150 yields or fails, and the connector 164, along with the upper boom portion 104 coupled thereto, are displaced toward the power unit 14 (referred to herein as a second failed state), as shown in FIGS. 14 and 15. In other words, application of the external force F₂ to the upper boom portion 104 causes displacement of the connector 164 in the second bending direction 252, and when the magnitude of the external force F₂ is sufficient to cause one or more internal stresses in each of the first and second coupling plates 152, 154 to equal or exceed the yield stress threshold of the first and second coupling plates 152, 154 (i.e., the external force F₂ on the upper boom portion 104 causes the connector 164 to create stresses in each of the first and second coupling plates 152, 154 equal to or in excess of a yield stress threshold of each first and second coupling plates 152, 154), the first and second coupling plates 152, 154 fail and begin to plastically deform, i.e., bend, in the second bending direction 252, as indicated by bent first and second coupling plates 152″, 154″ in FIG. 15. The first and second coupling plates 152, 154 bend about an axis (not shown) that is parallel to axis c (see FIG. 12).

A yield stress threshold of the adapter 150 may equal the yield stress threshold for each of first and second coupling plates 152, 154, i.e., the yield strength σ_{yield strength} of the material from which each of the first and second coupling plate 152, 154 is formed. Failure and deformation of the first and second coupling plates 152, 154 allows the connector 164, along with the upper boom portion 104 coupled thereto, to rotate or be displaced in the second bending direction 252, i.e., toward the power unit 14 (in FIG. 15, the upper boom portion 104 is not shown (see FIG. 28), and the lower element 166 of the connector 164 is shown with dashed lines to illustrate the internal structure of the adapter 150). As described herein, the material(s) and/or structure/geometry of the first and second coupling plates 152, 154 may be selected so that the first and second coupling plates 152, 154 have a yield stress threshold that allows the first and second coupling plates 152, 154 to begin failing before the one or more external forces applied to the upper boom portion 104 cause damage to, or failure of, the structural integrity of the operator's backrest 34, such that the first and second coupling plates 152, 154 act as a moment limiter for the operator's backrest 34.

The first and second coupling plates 152, 154 may permanently and plastically deform to allow controlled movement of the upper boom portion 104 to a final deformed angular position relative to the base mount 102, as shown in FIGS. 14 and 15. The first upper and lower plate mounts 156, 158 provide a second stop that limits rotation of the connector 164, and the upper boom portion 104 coupled thereto, in the second bending direction 252. The connector 164 in FIGS. 14 and 15 is depicted as having rotated by about 45 degrees from a normal operating position with respect to the main body 106 of the base mount 102. A lower surface of the first upper plate mount 156 may comprise a sloped or chamfered edge 157, and an upper surface of the first lower plate mount 158 may comprise a corresponding sloped or chamfered edge 159. If the connector 164 continues rotating in the second bending direction 252 beyond about 45 degrees, at about 90 degrees or any angle greater than 45 degrees, the chamfered edge 157 of the first upper plate mount 156 engages the chamfered edge 159 of the first lower plate mount 158, with engagement between the chamfered edges 157, 159 acting as the second stop to halt rotation of the connector 164 beyond about 90 degrees. The first and second coupling plates 152, 154 may also be used with the base mount 1102 and upper boom portion 1104 described in detail with respect to FIGS. 22 and 24, in which a portion of the base mount 1102 and the upper boom portion 1104 form first and second stops.

The first and second coupling plates 152, 154 may resist rotation of the connector 164 in the second bending direction 252 and may absorb at least a portion of the energy resulting from the impact to slow and eventually stop the displacement of the upper boom portion 104. The amount of resistance provided by the first and second coupling plates 152, 154 may be selected based on the shape, geometry, and/or material selected for the first and second coupling plates 152, 154 and the configuration of the first and second coupling plates 152, 154 with respect to each other and/or with respect to the upper and lower plate mounts 156, 160 and 158, 162. The adapter 150 is configured such that upon removal of the one or more external forces, i.e., force F₂, causing the one or more internal stresses in the first and second coupling plates 152, 154 equal to or in excess of the yield stress threshold of the first and second coupling plates 152, 154 resulting in plastic deformation of the first and second coupling plates 152, 154, the plastically deformed first and second coupling plates 152″, 154″ further hold the upper boom portion 104 at the final deformed angular position to prevent free-falling over of the upper boom portion 104. As shown in FIG. 15, the first and second coupling plates 152″, 154″ plastically deform/bend upon failure but typically do not break or fracture, such that the first and second coupling plates 152″, 154″ remain connected/attached to connector 164 and the base mount 102, thereby preventing or minimizing damage to the truck 10, the base mount 102 and the upper boom portion 104, the accessory 300, and/or adjacent personnel or objects. Even at very high magnitudes of the impact force F₂ occurring at the upper boom portion 104, both of the first and second coupling plates 152″, 154″ will remain coupled to the connector 164 and the base mount 102 as the object imparting the impact force F₂ moves over or past the upper boom portion 104, i.e., the adapter 150 is fixedly coupled to the upper boom portion 1104 via the connector 164 and the base mount 1102 and has sufficient strength to remain coupled to the upper boom portion 104 and the base mount 102, as the first and second coupling plates 152″, 154″ will yield or deflect before the upper and lower plate mounts 156, 160 and 158, 162 and/or the first and second coupling plates 152″, 154″ separate from one another or from the upper boom portion 104 or the base mount 102. Further, the angle of deflection of the first and second coupling plates 152″, 154″ will stabilize at the final deformed angular position once the object imparting the impact force F₂ is no longer in contact with the upper boom portion 104, i.e., the first and second coupling plates 152″, 154″ have sufficient rigidity that the weight of the upper boom portion 104 will have little or no impact on the amount of deformation occurring at the first and second coupling plates 152″, 154″ after the impact force has been removed. Hence, the plastically deformed first and second coupling plates 152″, 154″ hold the upper boom portion 104 at the final deformed angular position in which the first and second coupling plates 152″, 154″ are located when the impact force is removed, i.e., the upper boom portion 104 is held in a fixed position and the first and second coupling plates 152″, 154″ do not further deform or move angularly relative to the base mount 102 after the impact force has been removed and the first and second coupling plates 152″, 154″ have stabilized, thereby preventing free-falling over of the upper boom portion 104.

With reference to FIG. 27, the length L₃ of the main body 106 of the base mount 102 may be adjusted or configured to place or locate the adapter 150 at a desired height H₁ above the forks 16 and the operator's platform 32. The height H₁ may be based in part on the operator height H₂ for a 95^{th} percentile adult male. In particular, the height H₁ may be greater than the operator height H₂ to ensure that the adapter 150 is located high enough above the operator that the upper boom portion 104 does not contact the operator upon failure of the adapter 150. For example, the operator height H₂ may be 75 inches, and the height H₁ may be 84 inches.

As shown in FIG. 27, positioning the adapter 150 at the height H₁ may also help to prevent damage to the truck 10, the boom assembly 100, the accessory 300, and/or adjacent personnel and objects by ensuring that when the adapter 150 enters the first or second failed state, the upper boom portion 104 remains clear of the rest of the truck 10, including, for example, the antenna 66, the forks 16, and/or a load positioned on the forks 16, and remains clear of adjacent objects and personnel. With reference to FIGS. 12, 13, and 27, the upper boom portion 104 may deflect relative to the base mount 102, i.e., relative to the vertical axis v, in the first bending direction 250 toward the forks 16 by an angle α₁, in which the angle α₁ is greater than 0 degrees and up to about 90 degrees. With reference to FIGS. 14, 15, and 27, the upper boom portion 104 may deflect relative to the base mount 102, i.e., relative to the vertical axis v, in the second bending direction 252 toward the power unit 14 by an angle α₂, in which the angle α₂ is greater than 0 degree and up to about 90 degrees. In the examples shown in FIGS. 12-15 where the boom assembly 100 is depicted in the first and second failed states, respectively, the upper boom portion 104 is illustrated as being deflected at an angle of approximately 45 degrees with respect to the base mount 102.

The adapter 150 and the components thereof may be modular or interchangeable, such that upon failure, the adapter 150 may be removed and replaced and the boom assembly 100 may be reassembled. For example, with reference to FIGS. 13 and 15, the upper and lower plate mounts 156, 160 and 158, 162 and the bent first and second coupling plates 152′, 154′ or 152″, 154″ joined thereto may be replaced by removing the fasteners 204, 206 (see FIGS. 7 and 8) securing the upper and lower plate mounts 156, 158 and 160, 162 to the base mount 102 and the connector 164, removing the adapter 150 from the boom assembly 100, and replacing the damaged adapter 150 with a new adapter. Because the adapter 150 yields to large impact forces applied to the boom assembly 100, the adapter 150 may help to prevent damage to the base mount 102, the upper boom portion 104, and/or the accessory 300, thereby reducing the cost of replacement, preventing or minimizing the need to repair the truck 10, and reducing the amount of down time before the truck 10 can resume normal operations.

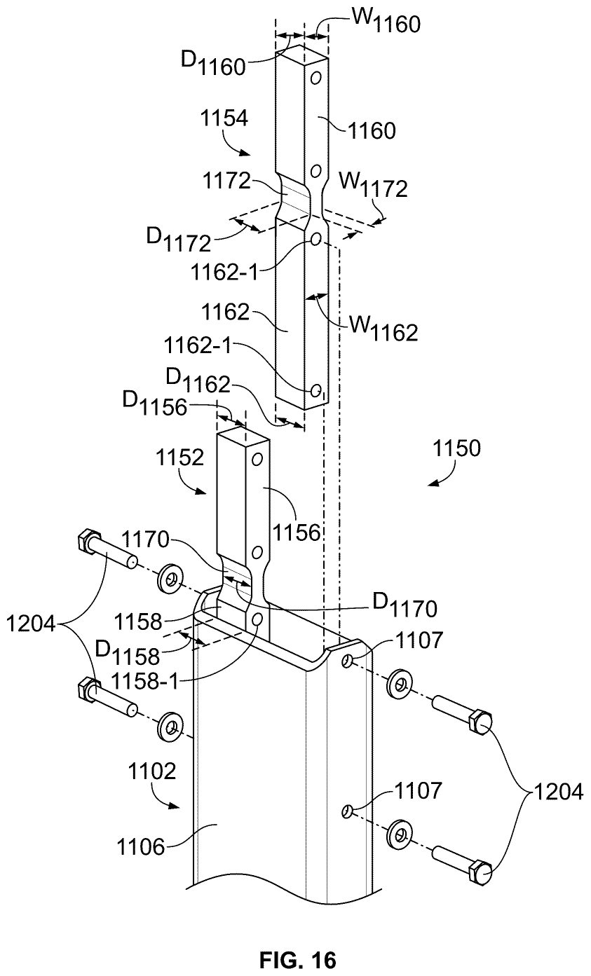

With reference to FIGS. 16-20, another exemplary adapter 1150 coupling a base mount 1102 to an upper boom portion 1104 of a boom assembly 1100 is described in detail. The boom assembly 1100 may be substantially similar to the boom assembly 100 shown in FIGS. 1-15, except as described herein. The adapter 1150 comprises at least one coupling member that includes at least one bar. In the example shown, the at least one coupling member comprises a first coupling bar 1152 and a second coupling bar 1154 that are each coupled to an upper boom portion 1104 and a base mount 1102. Although two coupling bars 1152, 1154 are shown, it should be understood that the at least one coupling member may include a single bar, e.g., one of the first and second coupling bars 1152 or 1154.

The first and second coupling bars 1152, 1154 may be substantially similar to each other and may each comprise a respective upper section 1156, 1160 that is coupled to the upper boom portion 1104; a lower section 1158, 1162 that is coupled to the base mount 1102; and a middle section 1170, 1172 joining the respective upper and lower sections 1156, 1158 and 1160, 1162. As shown in FIGS. 16 and 18, the upper and lower sections 1156, 1158 of the first coupling bar 1152 each comprise a respective first dimension or width W₁₁₅₆, W₁₁₅₈ and a second dimension or depth D₁₁₅₆, D₁₁₅₈, with the widths W₁₁₅₆, W₁₁₅₈ being substantially equal to each other and the depths D₁₁₅₆, D₁₁₅₈ being substantially equal to each other. The middle section 1170 of the first coupling bar 1152 comprises a width W₁₇₀ and a depth D₁₁₇₀, in which one or both of the width W₁₁₇₀ and the depth D₁₁₀ of the middle section 1170 are reduced or decreased, as compared to the corresponding width W₁₁₅₆, W₁₁₅₈ and/or depth D₁₁₅₆, D₁₁₅₈ of the upper and lower sections 1156, 1158. In the example shown in FIG. 18, the middle section 1170 comprises a pair of upper curved surfaces 1170A, a pair of lower curved surfaces 1170B, and a pair of substantially planar middle surfaces 1170C (only of one each of the upper and lower curved surfaces 1170A, 1170B and the substantially planar middle surfaces 1170C is labeled), in which the upper and lower curved surfaces 1170A, 1170B curve continuously inward toward the substantially planar middle surfaces 1170C.

In examples, the first and second coupling bars 1152, 1154 may be formed from steel, have upper and lower sections 1156, 1158 each comprising a respective width W₁₁₅₆, W₁₁₅₈ from ½ inch to 2.0 inches, and a respective depth D₁₁₅₆, D₁₁₅₈ from ½ inch to 2.5 inches, middle sections 1170, 1172 each comprising a respective width W₁₁₇₀ from ¼ inch to ¾ inch and a respective depth D₁₁₇₀ from ½ inch to 2.5 inches.

As shown in FIG. 16, the upper, lower, and middle sections 1160, 1162, 1172 of the second coupling bar 1154 likewise each comprise a respective width W₁₁₆₀, W₁₁₆₂, W₁₁₇₂ and depth D₁₁₆₀, D₁₁₆₂, D₁₁₇₂, in which the widths W₁₁₆₀, W₁₁₆₂ of the upper and lower sections 1160, 1162 are substantially equal to each other; the depths D₁₁₆₀, D₁₁₆₂ of the upper and lower sections 1160, 1162 are substantially equal to each other; and one or both of the width W₁₁₇₂ and the depth D₁₁₇₂ of the middle section 1172 are reduced or decreased, as compared to the corresponding width W₁₁₆₀, W₁₁₆₂ and/or depth D₁₁₆₀, D₁₁₆₂ of the upper and lower sections 1160, 1162.

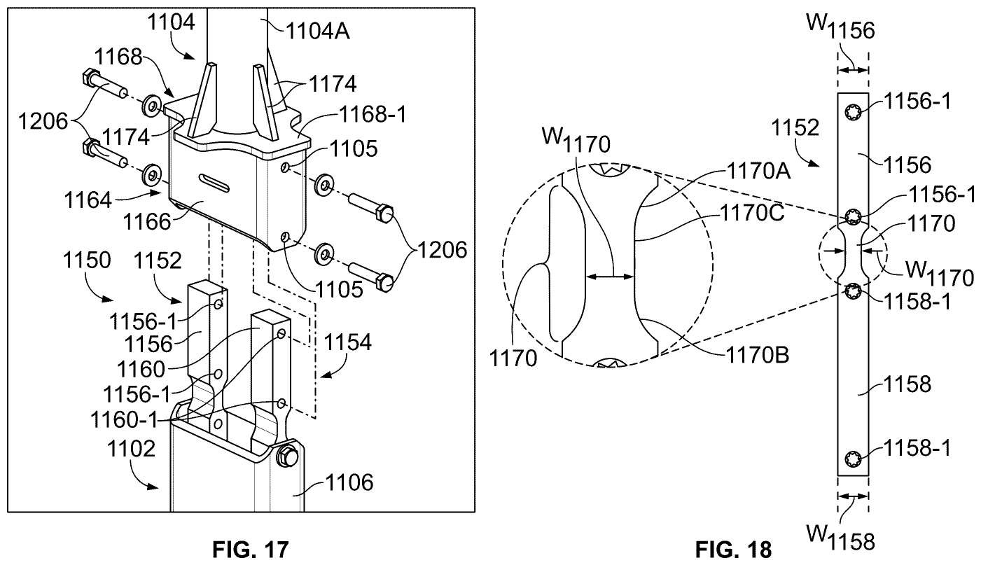

The base mount 1102 may comprise a main body 1106, in which the main body 1106 comprises a generally rectangular cross-section. The main body 1106 comprises a plurality of apertures 1107 formed in the sides thereof, as shown in FIG. 16. In the example shown, a right side of the main body 1106 comprises two apertures 1107. Although not visible, a left side of the main body 1106 also comprises two apertures. The lower sections 1158, 1162 of the first and second coupling bars 1152, 1154 each comprise a plurality of corresponding threaded apertures 1158-1, 1162-1 extending through the depth D₁₁₅₈, D₁₁₆₂ of the respective lower sections 1158, 1162. The first and second coupling bars 1152, 1154 may be configured, i.e., sized and shaped, to fit and be received inside the main body 1106 of the base mount 1102. To secure the adapter 1150, specifically the first and second coupling bars 1152, 1154 of the adapter 1150, to the main body 1106 of the base mount 1102, the lower section 1158, 1162 of each of the first and second coupling bars 1152, 1154 may be inserted into the base mount 1102 so that the lower sections 1158, 1162 are received in the main body 1106 and the apertures 1158-1, 1162-1 formed in the lower sections 1158, 1162 of the first and second coupling bars 1152, 1154 are aligned with the apertures 1107 formed in the main body 1106, as shown in FIG. 16. Fasteners 1204 extend through the apertures 1107 formed in the right side of the main body 1106 and are received in the apertures 1162-1 formed in the lower section 1162 of the second coupling bar 1154. Fasteners 1204 similarly extend through the apertures (not visible) formed in the left side of the main body 1106 and are received in the apertures 158-1 formed in the lower section 1158 of the first coupling bar 1152. Washers (not labeled) may be positioned between the fasteners 204 and the main body 1106. When the first and second coupling bars 1152, 1154 are installed in the main body 1106 of the base mount 1102, the upper sections 1156, 1160 and the middle sections 1170, 1172 extend above the main body 1106, as shown in FIGS. 16 and 17.

The upper boom portion 1104 may be coupled to the adapter 1150. As shown in FIGS. 1 and 17, the upper boom portion 1104 may comprise a first section 1104A and a second section 1104B. Similar to the upper boom portion 104 described herein, the upper boom portion 1104 shown in FIG. 17 may comprise a different cross-section, i.e., a generally circular cross-section, as compared to the generally rectangular cross-section of the main body 1106 of the base mount 1102, and a connector 1164 provides a transition between the generally rectangular cross-section of the main body 1106 to the generally circular cross-section of the upper boom portion 1104. In other examples (not shown), the base mount 1102 and the upper boom portion 1104 may comprise the same cross-sectional shape. The connector 1164 shown in FIG. 17, which may be substantially similar to the connector 164, may be positioned between the adapter 1150 and the upper boom portion 1104 and comprises a lower element 1166 having a cross-sectional shape (i.e., generally rectangular) and dimensions that mirror the cross-sectional shape and dimensions of the main body 1106 of the base mount 1102. The lower element 1166 is coupled, e.g., via welding, to a lower surface (not visible) of an adapter plate 1168, and the first section 1104A of the upper boom portion 1104 is coupled, e.g., via welding, to an upper surface 1168-1 of the adapter plate 1168 opposite the lower surface. Gussets 1174 may be coupled, e.g., via welding, to the first section 1104A of the upper boom portion 1104 and may be further coupled, e.g., via welding, to the upper surface 1168-1 of the adapter plate 1168.

With continued reference to FIG. 17, the lower element 1166 of the connector 1164 comprises a plurality of apertures 1105 formed in the sides thereof. In the example shown, a right side of the lower element 1166 comprises two apertures 1105. Although not visible, a left side of the lower element 1166 also comprises two apertures. The upper sections 1156, 1160 of the first and second coupling bars 1152, 1154 each comprise a plurality of corresponding threaded apertures 1156-1, 1160-1 extending through the depth D₁₁₅₆, D₁₁₆₀ (not labeled in FIG. 17; see FIG. 16) of the respective upper sections 1156, 1160. The first and second coupling bars 1152, 1154 may be configured, i.e., sized and shaped, to fit and be received inside the lower element 1166 of the connector 1164. To secure the upper boom portion 1104 to the adapter 1150, specifically to the first and second coupling bars 1152, 1154 of the adapter 1150, the lower element 1166 of the connector 1164 may be placed over the upper sections 1156, 1160 of the first and second coupling bars 1152, 1154 and positioned so that the upper sections 1156, 1160 are received in the lower element 1166 and the apertures 1156-1, 1160-1 formed in the first and second coupling bars 1152, 1154 are aligned with the apertures 1105 formed in the lower element 1166. Fasteners 1206 extend through the apertures 1105 formed in the right side of the lower element 1166 and are received in the apertures 1160-1 formed in the upper section 1160 of the second coupling bar 1154. Although not visible in FIG. 17, fasteners 1206 similarly extend through apertures formed in the left side of the lower element 1166 and are received in the apertures 1156-1 formed in the upper section 1156 of the first coupling bar 1152. Washers (not labeled) may be positioned between the fasteners 1206 and the lower element 1166.

In the example shown in FIGS. 1, 19, and 27, upon coupling of the upper boom portion 1104 to the adapter 1150 and when the adapter 1150 is in a normal operating position (i.e., prior to failure as described herein), the first and second coupling bars 1152, 1154 may extend generally vertically and may be generally parallel to the main body 1106 of the base mount 1102. As shown in FIGS. 1 and 20, a cover 288 may optionally be placed over the adapter 1150 and may extend from the lower element 1166 of the connector 1164 to the main body 1106 of the base mount 1102 to cover the first and second coupling bars 1152, 1154.

As described with respect to FIGS. 25 and 26, the accessory 300 may be coupled to a distal end 1104-1 of the upper boom portion 1104 prior to, or after, coupling of the upper boom portion 1104 to the adapter 1150, e.g., via the adapter bracket 302 or via other suitable attachment means, and the upper boom portion 1104 may be configured to place the accessory 300 at the desired location.

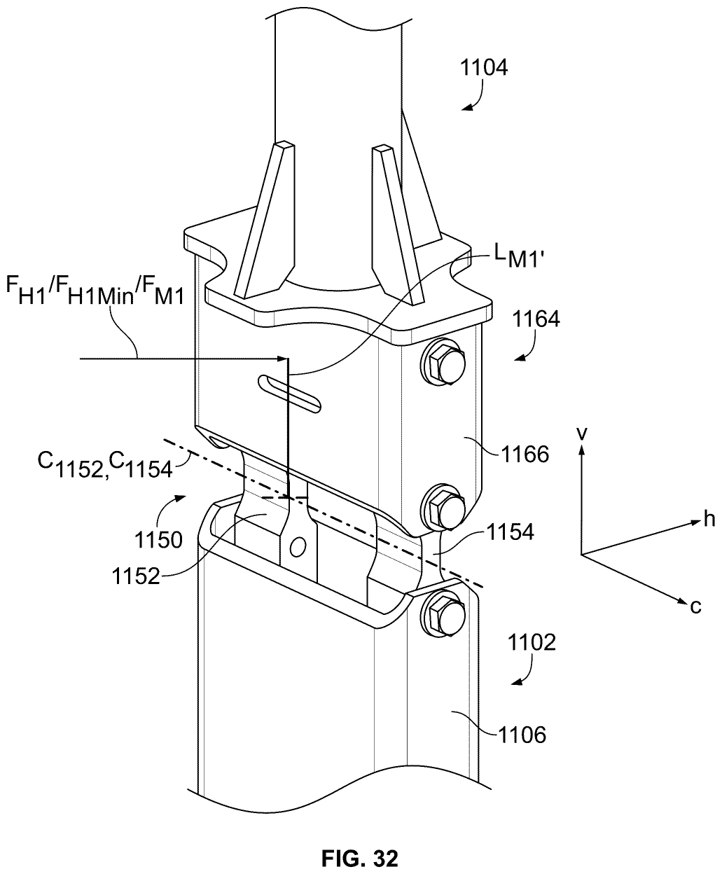

Because the boom assembly 1100 may extend generally vertically above the operator's platform 32 and generally horizontally over the forks 16, the boom assembly 1100 is subjected to a variety of standard application forces during normal operation of the truck 10 and may be subjected to additional forces, such as when the boom assembly 1100 collides with an object and/or the truck 10 collides with another object. With reference to FIG. 28, the upper boom portion 1104 may collide with an object and the boom assembly 1100 may be subjected to forces directly incident on the upper boom portion 1104 at any angle, such as exemplary external force F₁ or force F₂, as described in detail with respect to the boom assembly 100. These forces may have force components coincident or parallel with a horizontal axis h, a vertical axis v, and/or an out-of-plane axis c, which axes are shown in FIGS. 1 and 32. The force F₁ may be caused by an object engaging/striking a first wall 1104A-1 of the first section 1104A of the upper boom portion 1104 and may cause the boom assembly 1100 to bend in the bending direction 250 toward the forks 16. Alternatively, the boom assembly 1100 may be subjected to the force F₂, e.g., by an object acting on a second wall 1104A-2 of the first section 1104A of the upper boom portion 1104 or acting on the accessory 300, in which the force F₂₀ may cause the boom assembly 1100 to bend in the second bending direction 252 toward the power unit 14.

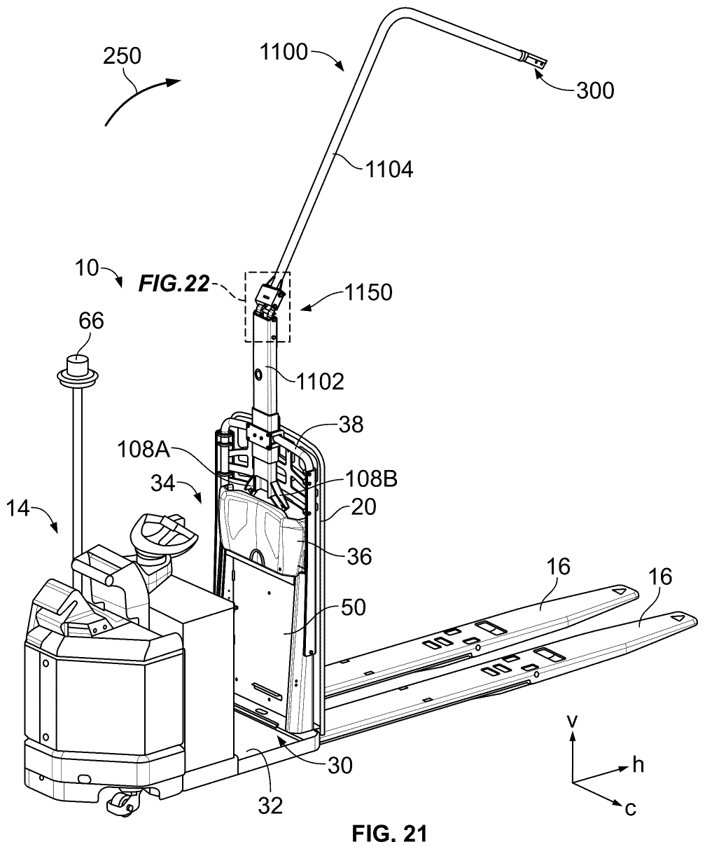

Without the adapter 1150 in accordance with the present disclosure, these external forces F₁ or F₂ may generate stresses on the boom assembly 1100, the operator's backrest 34, and other components of the truck 10 that may cause damage or failure in structural integrity. As shown in FIGS. 1, 19, and 28, the adapter 1150 is configured to maintain the boom assembly 1100 in a normal (e.g., upright) operating position when the upper boom portion 1104 is subjected to standard application forces during normal operation of the truck 10, i.e., when the upper boom portion 1104 is subjected to one or more external forces causing one or more internal stresses in the first and second coupling bars 1152, 1154 that are below a yield stress threshold of each of the first and second coupling bars 1152, 1154. The adapter 1150 is further configured to yield or fail in a controlled manner, as shown in FIGS. 21-24, when the upper boom portion 1104 is subjected to one or more external forces causing one or more internal stresses in each of the first and second coupling bars 1152, 1154 equal to, or in excess of, the yield stress threshold of each of the first and second coupling bars 1152, 1154. The first and second coupling bars 1152, 1154 may be designed so that the adapter 1150 yields or fails before one or more external forces applied to the upper boom portion 1104 cause stresses in the operator's backrest 34 sufficient to result in damage or failure in the structural integrity of the operator's backrest 34.

As described herein, when a force, such as exemplary force F₂ illustrated in FIG. 28, acts on the second wall 1104A-2, a moment M₂₀₀ of the force F₂ equals a magnitude of the force F₂ (i.e., its component parallel to the horizontal axis h; see FIG. 1) times a length L_{M2} extending from where the force F₂ impacts or is applied to the second wall 1104A-2 to a location anywhere on the operator's backrest 34 (as the base mount 1102 is coupled to the operator's backrest 34), such as where the first and second flanges 108A, 108B (not visible in FIG. 28; see FIGS. 2 and 3) are coupled to the operator's backrest 34. The operator's backrest 34 will experience substantial bending stress from the moment M₂₀₀. A geometry of, and material used for, the main body 1106 of the base mount 1102 and upper boom portion 1104 are generally selected so that the main body 1106 and the upper boom portion 1104 have a high section modulus to withstand impact forces. Hence, when a force, such as force F₂, acts on the boom assembly 1100, stresses on the boom assembly 1100 and the operator's backrest 34 resulting from the force F₂ and its corresponding moment M₂₀₀ are more likely to cause damage to the structural integrity of the operator's backrest 34 than the boom assembly 1100.

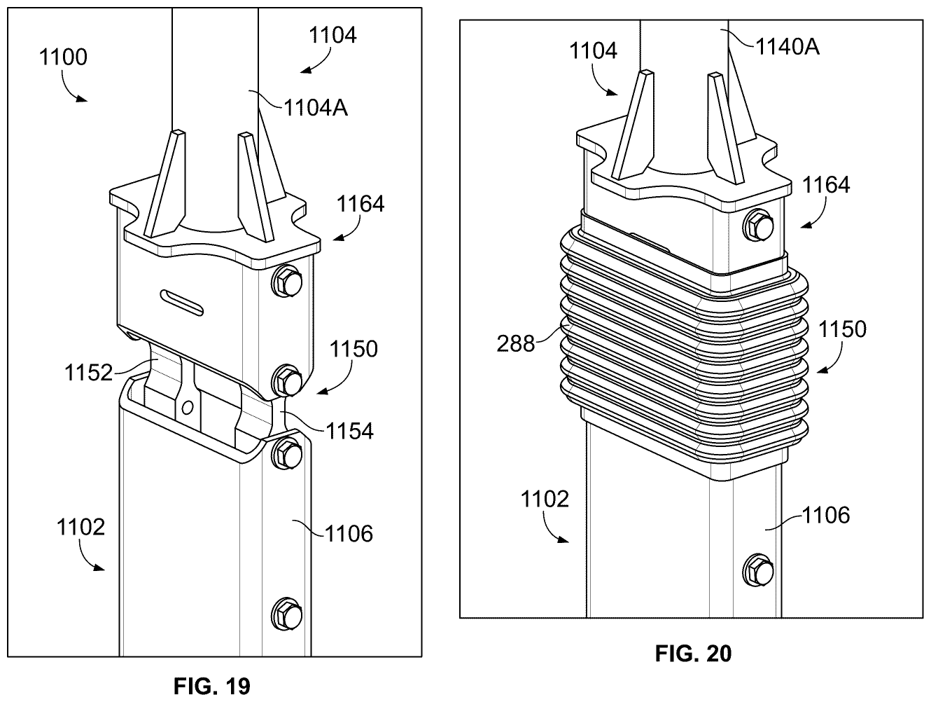

As described herein with respect to the boom assembly 100, a force F_{H1} is applied at a height above the forks 16 and the operator's platform 32, see FIGS. 29 and 32 for the location where the force F_{H1} is applied, which causes an internal moment M_{H1} from the force F_{H1} to be developed within the operator's backrest 34, and a bending stress in the operator's backrest 34 resulting from moment M_{H1} may be calculated using Equation (1). A moment M_{H1}, is calculated at each determined section modulus Z for the operator's backrest 34, and the moment M_{H1i} having the lowest value from all values of the moment M_{H1i}, calculated, which equals the smallest moment M_{H1i} to cause damage to the operator's backrest 34, is designated as a minimum moment value M_{H1Min}, and a magnitude of a corresponding force F_{H1Min} may be determined, which force F_{H1Min} is likely to cause structural integrity damage to the operator's backrest 34. The force F_{H1Min} may be determined by dividing the moment M_{H1Min} by a length corresponding to the minimum moment M_{H1Min}, e.g., the length corresponding to the section modulus Z corresponding to and from which minimum moment M_{H1Min} was determined. It is desirable to have each of the first and second coupling bars 1152, 1154 (not shown in FIG. 29; see FIG. 19) fail prior to structural integrity damage occurring at the operator's backrest 34. Hence, the force F_{H1Min} may be multiplied by a safety factor, such as 0.5 or any other value desired to calculate a modified force F_{M1}.

As illustrated in FIGS. 29 and 32, the force F_{H1Min} corresponding to the moment M_{H1i} having the lowest value from all values of the moment M_{H1i} calculated is applied to a section of the upper boom portion 1104, specifically to a section of the connector 1164, which location where the force F_{H1Min} is applied is spaced a distance from an approximate center C₁₁₅₂, C₁₁₅₄ of the respective middle section 1170, 1172 of the first and second coupling bars 1152, 1154 equal to length L_{M1′}. Using the modified force F_{M1} instead of the force F_{H1Min}, which force F_{M1} is presumed to be applied at the same location on the upper boom portion 1104 as the force F_{H1Min}, a moment M_{FM1} of the modified force F_{M1} about an axis passing through the center C₁₁₅₂, C₁₁₅₄ of the first and second coupling bars 1152, 1154 equals a magnitude of the modified force F_{M1} (i.e., its component parallel to the horizontal axis h) times the length L_{M1′} extending from where the modified force F_{M1} impacts or is applied to the connector 1164 to the center C₁₁₅₂, C₁₁₅₄ of the first and second coupling bars 1152, 1154.

The total stresses σₜₒₜₐₗ occurring within each of the first and second coupling bars 1152, 1154, when the modified force F_{M1} is applied to the upper boom portion 104/connector 1164 at the location illustrated in FIGS. 29 and 32, may be set equal to a yield strength of the material from which each of the first and second coupling bars 1152, 1154 is formed, such as a specific grade of steel. Yield strengths for such materials are well known. When the total stresses σₜₒₜₐₗ occurring in each one of the first and second coupling bars 1152, 1154 equals the yield strength σ_{yield strength} of the material from which each of the first and second coupling bars 1152, 1154 is formed, each of the first and second coupling bars 1152, 1154 will fail or yield, i.e., permanently deform or bend. The yield strength σ_{yield strength} of the material from which each of the first and second coupling bars 1152, 1154 is formed is equal to a yield stress threshold for each of the first and second coupling bars 1152, 1154, which also equals a yield stress threshold for the adapter 1150. Setting total stresses σₜₒₜₐₗ equal to the yield strength σ_{yield strength} of the material from which each of the first and second coupling bars 1152, 1154 is formed may be expressed by the following Equation (6):

$${σ}_{total} = {σ}_{yield strength} = 0.5 \times {F}_{M 1} \times {L}_{M 1 ’} / ( {Z}_{B a r} )$$

where σₜₒₜₐₗ=σ_{yield strength}=a yield strength of the material(s) comprising each of the first and second coupling bars 1152, 1154, such as steel; and
Z_{Bar}=section modulus of the middle section 1170, 1172 of each of the first and second coupling bars 1152, 1154.

Z_{Bar} may be determined for a middle section 1170, 1172 of each of the first and second coupling bars 1152, 1154 from the following Equation (7).

$${Z}_{B a r} = \frac{W * {A}_{b a r}}{6}$$

When the first and second coupling bars 1152, 1154 have the same geometry and are made from the same material, they will each have the same section modulus Z_{Bar}. The width W for the middle section 1170 for the first coupling bar 1152 equals width W₁₁₇₀ and the width W for the middle section 1172 for the second coupling bar 1154 equals width W₁₁₇₂. The cross-sectional area A_{bar} for the middle section 1170 of the first coupling bar 1152 may be determined by multiplying the width W₁₁₇₀ of the middle section 1170 of the first coupling bar 1152 by the depth D₁₁₇₀ of the middle section 1170 of the first coupling bar 1152. The cross-sectional area A_{bar} of the middle section 1172 for the second coupling bar 1154 may be determined by multiplying the width W₁₁₇₂ of the middle section 1172 of the second coupling bar 1154 by the depth D₁₁₇₂ of the middle section 1172 of the second coupling bar 1154.

Hence, various combinations of the width W and the cross-sectional area Aₚₗₐₜₑ for each of the first and second coupling bars 1152, 1154 may be substituted into Equations (6) and (7) and appropriate values for the width W and the cross-sectional area A_{bar} are selected. Preferably, the cross-sectional area A_{bar} is selected to be sufficiently large to minimize deflection of the upper portion and maximize resiliency to prevent fatigue of the first and second coupling bars 1152, 1154. Using Equations (6) and (7), each of the first and second coupling bars 1152, 1154 is designed so that the first and second coupling bars 1152, 1154 fail when the modified force F_{M1} is applied to the upper boom portion 1104/the connector 1164 at the location illustrated in FIGS. 29 and 32 or a moment is generated by a force F applied anywhere along the upper boom portion 104 and having a moment arm extending to any location on the backrest 34, in which the moment generated by that force F is equal to or greater than the moment M_{FM1}. Hence, both of the first and second coupling bars 1152, 1154 will fail or yield prior to structural integrity damage occurring at the operator's backrest 34.

Determining the modified force F_{M1} and the corresponding moment M_{FM1} may be found using finite element analysis methods so as to allow the width W and the cross-sectional area Aₚₗₐₜₑ for each of the first and second coupling bars 1152, 1154 to be calculated from Equations (6) and (7).

It is further contemplated that each of the first and second coupling bars 1152, 1154 may be designed via experimentation using actual boom assemblies (e.g., by applying one or more external forces to actual boom assemblies to allow each of the first and second coupling bars 1152, 1154 to be designed so that each of the first and second coupling bars 1152, 1154 yields or fails prior to structural integrity damage occurring at the operator's backrest 34). Hence, the first and second coupling bars 1152, 1154 are designed so that when one or more external forces are applied to a boom assembly sufficient to cause internal stresses in each of the first and second coupling bars 1152, 1154 equal to or in excess of the yield stress threshold of each of the first and second coupling bars 1152, 1154, each of the first and second coupling bars 1152, 1154 fails prior to structural integrity damage occurring at the operator's backrest 34. The first and second coupling bars 1152, 1154 may also be designed via one or more suitable computer modelling techniques such that each of the first and second coupling bars 1152, 1154 fails prior to structural integrity damage occurring at the operator's backrest 34.

As shown in FIG. 28, the upper boom portion 1104 may be subjected to an external impact force, i.e., exemplary force F₁, at an angle to the first wall 1104A-1 of the upper boom portion 1104 and generally extending toward the forks 16. When a horizontal component of the external force F₁ (indicated by line h) acting on the first wall 1104A-1 of the upper boom portion 1104 creates internal stresses in the first and second coupling bars 1152, 1154, equal to or in excess of the yield stress threshold of each of the first and second coupling bars 1152, 1154, i.e., equal to or in excess of the yield strength σ_{yield strength} of the material from which each of the first and second coupling bars 1152, 1154 is formed, the adapter 1150 yields or fails and enters the first failed state, and the connector 1164, along with the upper boom portion 1104 coupled thereto, are displaced toward the forks 16, as shown in FIGS. 21 and 22. In other words, application of the external force F₁ to the upper boom portion 1104 may cause displacement of the connector 1164 in the first bending direction 250, and when the magnitude of the external force F₁ is sufficient to cause one or more internal stresses in each of the first and second coupling bars 1152, 1154 to equal or exceed the yield stress threshold of each of the first and second coupling bars 1152, 1154 (i.e., the external force F₁ on the upper boom portion 1104 causes the connector 1164 to create stresses in the first and second coupling bars 1152, 1154 equal to or in excess of the yield stress threshold of each of the first and second coupling bars 1152, 1154), the first and second coupling bars 1152, 1154 fail and begin to plastically deform, i.e., bend, in the first bending direction 250, as indicated by bent first and second coupling bars 1152′, 1154′ in FIG. 22. A yield stress threshold of the adapter 1150 may equal the yield stress threshold for each of the first and second coupling bars 1152, 1154. Failure and deformation of the first and second coupling bars 1152, 1154 allows the connector 1164, along with the upper boom portion 1104 coupled thereto, to rotate or be displaced in the first bending direction 250, i.e., toward the forks 16.

The first and second coupling bars 1152, 1154 may be formed from the same material, e.g., a metal such as steel, and may have the same structure/geometry, such that the first and second coupling bars 1152, 1154 each have the same yield stress threshold. The respective width W₁₁₇₀, W₁₁₇₂ and depth D₁₁₇₀, D₁₁₇₂ of the middle section 1170, 1172 of each of the first coupling bar 1152 and the second coupling bar 1154, the cross-sectional area A_{bar} of the middle section 1170, 1172 of each of the first and second coupling bars 1152, 1154, and the material from which each of the first and second coupling bars 1152, 1154 is formed, which material has a given yield strength σyield strength defining the yield stress threshold of the first and second coupling bars 1152, 1154 may be selected, such that the first and second coupling bars 1152, 1154 fail or yield before the one or more external forces applied to the upper boom portion 104 cause damage to, or failure of, the structural integrity of the operator's backrest 34. In the example shown, the first and second coupling bars 1152, 1154 may bend at a location adjacent to the respective center C₁₁₅₂, C₁₁₅₄.

The first and second coupling bars 1152, 1154 plastically deform to allow controlled movement of the upper boom portion 1104 to a final deformed angular position relative to the base mount 1102, as shown in FIGS. 21 and 22. A first portion of an upper end surface of the base mount 1102, i.e., a first portion 1169-1 of an upper end surface 1169 of the base mount 1102, and a first portion of a lower end surface of the upper boom portion 1104, i.e., a first portion 1167-1 of a lower end surface 1167 of the lower element 1166 of the connector 1164, provide a first stop that limits rotation of the connector 1164, and the upper boom portion 1104 coupled thereto, in the first bending direction 250. The connector 1164 is depicted in FIGS. 21 and 22 as having rotated by about 45 degrees from a normal operating position with respect to the main body 1106 of the base mount 1102. The first portion 1167-1 of the lower end surface 1167 of the lower element 1166 may comprise a sloped or chamfered edge, and the first portion 1169-1 of the upper end surface 1169 of the base mount 1102 may comprise a corresponding sloped or chamfered edge. If the connector 1164 continues rotating in the first bending direction 250 beyond about 45 degrees, e.g., 90 degrees or any angle greater than 45 degrees, the sloped edge of the first portion 1167-1 of the lower end surface 1167 engages the sloped edge of the first portion 1169-1 of the upper end surface 1169, with engagement between the sloped edges acting as the first stop to halt rotation of the connector 1164 beyond about 90 degrees.

The first and second coupling bars 1152, 1154 may resist rotation of the connector 1164 in the first bending direction 250 and may absorb at least a portion of the energy resulting from the impact to slow and eventually stop the displacement of the upper boom portion 1104. The amount of resistance provided by the first and second coupling bars 1152, 1154 may be selected based on the material and/or geometry. The adapter 1150 is configured such that upon removal of the one or more external forces, i.e., force F₁, causing the one or more internal stresses in the first and second coupling bars 1152, 1154 to equal or exceed the yield stress threshold of the first and second coupling bars 1152, 1154, the first and second coupling bars 1152, 1154 may hold the upper boom portion 1104 at the final deformed angular position to prevent free-falling over of the upper boom portion 1104. As shown in FIG. 22, the first and second coupling bars 1152, 1154 plastically deform/bend upon failure and are designed not to break, fracture or shear, such that the first and second coupling bars 1152, 1154 remain connected/attached to connector 1164 and the base mount 1102, thereby preventing or minimizing damage to the truck 10, the base mount 1102 and the upper boom portion 1104, the accessory 300, and/or adjacent personnel or objects. Even at very high magnitudes of the impact force F₁ occurring at the upper boom portion 1104, both of the first and second coupling bars 1152′, 1154′ will remain coupled to the connector 1164 and the base mount 1102 as the object imparting the impact force F₁ moves over or past the upper boom portion 1104, i.e., the adapter 1150 is fixedly coupled to the upper boom portion 1104 via the connector 1164 and the base mount 1102 and has sufficient strength to remain coupled to the upper boom portion 1104 and the base mount 1102, as the first and second coupling bars 1152′, 1154′ will yield or deflect before the first and second coupling bars 1152′, 1154′ separate from the upper boom portion 1104 and/or the base mount 1102. Further, the angle of deflection of the first and second coupling bars 1152′, 1154′ will stabilize at the final deformed angular position once the object imparting the impact force F₁ is no longer in contact with the upper boom portion 1104, i.e., the first and second coupling bars 1152′, 1154′ have sufficient rigidity that the weight of the upper boom portion 1104 will have little or no impact on the amount of deformation occurring at the first and second coupling bars 1152′, 1154′ after the impact force has been removed. Hence, the plastically deformed first and second coupling bars 1152′, 1154′ hold the upper boom portion 1104 at the final deformed angular position in which the first and second coupling bars 1152′, 1154′ are located when the impact force is removed, i.e., the upper boom portion 1104 is held in a fixed position and the first and second coupling bars 1152′, 1154′ do not further deform or move angularly relative to the base mount 1102 after the impact force has been removed and the first and second coupling bars 1152′, 1154′ have stabilized, thereby preventing free-falling over of the upper boom portion 1104.

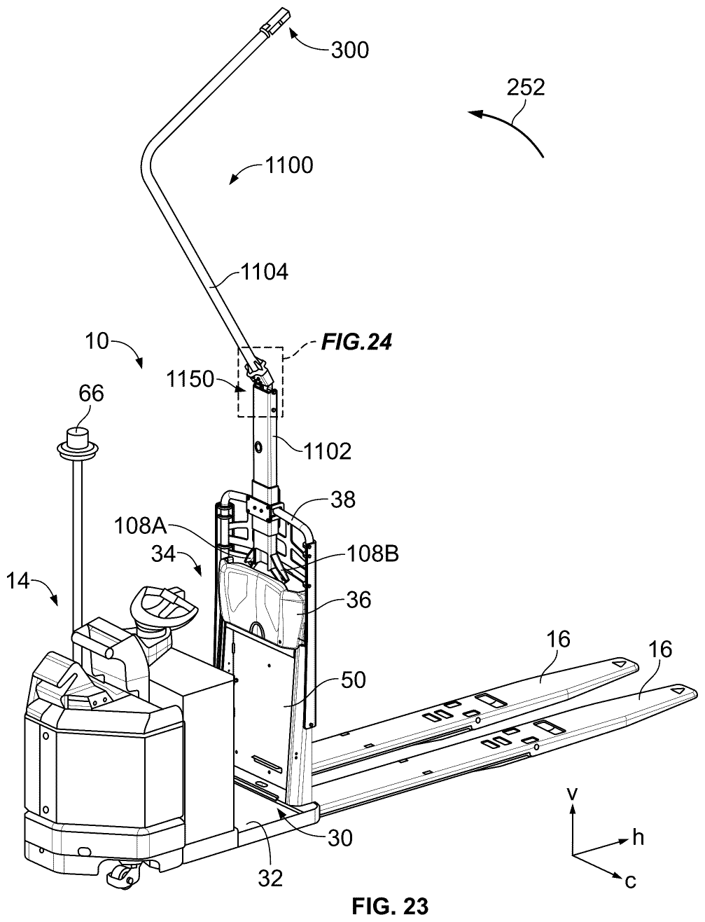

As shown in FIG. 28, the upper boom portion 1104 may be subjected to an external impact force, i.e., exemplary force F₂, in a direction generally toward the power unit 14. When the force F₂ acting on the second wall 1104A-2 of the upper boom portion 1104 creates one or more internal stresses in the first and second coupling bars 1152, 1154 equal to or in excess of the yield stress threshold of the first and second coupling bars 1152, 1154, the adapter 1150 yields or fails and enters the second failed state, and the connector 1164, along with the upper boom portion 1104 coupled thereto, are displaced toward the power unit 14, as shown in FIGS. 23 and 24. In other words, application of the external force F₂ to the upper boom portion 1104 causes displacement of the connector 1164 in the second bending direction 252, and when the magnitude of the external force F₂ is sufficient to cause one or more internal stresses in the first and second coupling bars 1152, 1154 to equal or exceed the yield stress threshold of the first and second coupling bars 1152, 1154 (i.e., the external force F₂ on the upper boom portion 1104 causes the connector 1164 to create stresses in the first and second coupling bars 1152, 1154 equal to or in excess of the respective yield stress threshold of each of the first and second coupling bars 1152, 1154), the first and second coupling bars 1152, 1154 fail and begin to plastically deform, i.e., bend, in the second bending direction 252, as indicated by bent first and second coupling bars 1152″, 1154″ in FIG. 24. Failure and deformation of the first and second coupling bars 1152, 1154 allows the connector 1164, along with the upper boom portion 1104 coupled thereto, to rotate or be displaced in the second bending direction 252, i.e., toward the power unit 14.

As described herein, the material(s) and/or structure/geometry of the first and second coupling bars 1152, 1154 may be selected so that the first and second coupling bars 1152, 1154 have a yield stress threshold that allows the first and second coupling bars 1152, 1154 to begin failing before the one or more external forces applied to the upper boom portion 1104 cause damage to, or failure of, the structural integrity of the operator's backrest 34. In the example shown, the first and second coupling bars 1152, 1154 may bend at a location adjacent to the respective center C₁₁₅₂, C₁₁₅₄. Hence, the yield stress threshold of the first and second coupling bars 1152, 1154 may be designed so that the adapter 1150 yields or fails before one or more external forces applied to the upper boom portion 1104 cause an element or component of the truck 10, i.e., the operator's backrest 34, to which the boom assembly 1100 is coupled to fail. The boom assembly 1100 is considered to comprise the structure, i.e., the first and second brackets 116A, 116B and the first and second flanges 108A, 108B, for coupling the base mount 102 to the truck 10.

The first and second coupling bars 1152, 1154 plastically deform to allow controlled movement of the upper boom portion 1104 to a final deformed angular position relative to the base mount 1102, as shown in FIGS. 23 and 24. A second portion of the upper end surface of the base mount 1102, i.e., a second portion 1169-2 of the upper end surface 1169 of the base mount 1102, and a second portion of the lower end surface of the upper boom portion 1104, i.e., a second portion 1167-2 of the lower end surface 1167 of the lower element 1166 of the connector 1164, provide a second stop that limits rotation of the connector 1164, and the upper boom portion 1104 coupled thereto, in the second bending direction 252. The connector 1164 is depicted in FIGS. 23 and 24 as having rotated by about 45 degrees from a normal operating position with respect to the main body 1106 of the base mount 1102. The second portion 1167-2 of the lower surface 1167 of the lower element 1166 may comprise a sloped or chamfered edge, and the second portion 1169-2 of the upper end surface 1169 of the base mount 1102 may comprise a corresponding sloped or chamfered edge. If the connector 1164 continues rotating in the second bending direction 252 beyond about 45 degrees, e.g., 90 degrees or any angle greater than 45 degrees, the sloped edge of the second portion 1167-2 of the lower surface 1167 engages the sloped edge of the second portion 1169-2 of the upper end surface 1169, with engagement between the sloped edges acting as the second stop to halt rotation of the connector 1164 beyond about 90 degrees.

The first and second coupling bars 1152, 1154 may resist rotation of the connector 1164 in the second bending direction 252 and may absorb at least a portion of the energy resulting from the impact to slow and eventually stop the displacement of the upper boom portion 1104. The amount of resistance provided by the first and second coupling bars 1152, 1154 may be selected based on the material and/or geometry. The adapter 1150 is configured such that upon removal of the one or more external forces, i.e., force F₂, causing the one or more internal stresses in the first and second coupling bars 1152, 1154 equal to or in excess of the yield stress threshold of the first and second coupling bars 1152, 1154, the first and second coupling bars 1152, 1154 hold the upper boom portion 1104 at the final deformed angular position to prevent free-falling over of the upper boom portion 1104. As shown in FIG. 24, the first and second coupling bars 1152, 1154 plastically deform/bend upon failure but do not break or fracture, such that the first and second coupling bars 1152, 1154 remain connected/attached to connector 1164 and the base mount 1102, thereby preventing or minimizing damage to the truck 10, the base mount 1102 and the upper boom portion 1104, the accessory 300, and/or adjacent personnel or objects. Even at very high magnitudes of the impact force F₂ occurring at the upper boom portion 1104, both of the first and second coupling bars 1152″, 1154″ will remain coupled to the connector 1164 and the base mount 1102 as the object imparting the impact force F₂ moves over or past the upper boom portion 1104, i.e., the adapter 1150 is fixedly coupled to the upper boom portion 1104 via the connector 1164 and the base mount 1102 and has sufficient strength to remain coupled to the upper boom portion 1104 and the base mount 1102, as the first and second coupling bars 1152″, 1154″ will yield or deflect before the first and second coupling bars 1152″, 1154″ separate from the upper boom portion 1104 and/or the base mount 1102. Further, the angle of deflection of the first and second coupling bars 1152″, 1154″ will stabilize at the final deformed angular position once the object imparting the impact force F₂ is no longer in contact with the upper boom portion 1104, i.e., the first and second coupling bars 1152″, 1154″ have sufficient rigidity that the weight of the upper boom portion 1104 will have little or no impact on the amount of deformation occurring at the first and second coupling bars 1152″, 1154″ after the impact force has been removed. Hence, the plastically deformed first and second coupling bars 1152″, 1154″ hold the upper boom portion 1104 at the final deformed angular position in which the coupling bars 1152″, 1154″ are located when the impact force is removed, i.e., the upper boom portion 1104 is held in a fixed position and the first and second coupling bars 1152″, 1154″ do not further deform or move angularly relative to the base mount 1102 after the impact force has been removed and the first and second coupling bars 1152″, 1154″ have stabilized, thereby preventing free-falling over of the upper boom portion 1104.

With reference to FIG. 27, the length L₃ of the main body 1106 of the base mount 1102 may be adjusted or configured to place or locate the adapter 1150 at a desired height H₁ above the forks 16 and the operator's platform 32. The height H₁ may be based in part on the operator height H₂ for a 95^{th} percentile adult male. In particular, the height H₁ may be greater than the operator height H₂ to ensure that the adapter 1150 is located high enough above the operator that the upper boom portion 1104 does not contact the operator upon failure of the adapter 1150. For example, the operator height H₂ may be 75 inches, and the height H₁ may be 84 inches.

As shown in FIG. 27, positioning the adapter 1150 at the height H₁ may also help to prevent damage to the truck 10, the boom assembly 1100, the accessory 300, and/or adjacent personnel and objects by ensuring that when the adapter 1150 enters the first or second failed state, the upper boom portion 1104 remains clear of the rest of the truck 10, including, for example, the antenna 66, the forks 16, and/or a load positioned on the forks 16, and remains clear of adjacent objects and personnel. With reference to FIGS. 21, 22, and 27, the upper boom portion 1104 may deflect relative to the base mount 1102, i.e., relative to the vertical axis v, in the first bending direction 250 toward the forks 16 by an angle α₁, in which the angle α₁ is greater than 0 degrees and up to about 90 degrees. With reference to FIGS. 23, 24, and 27, the upper boom portion 1104 may deflect relative to the base mount 1102, i.e., relative to the vertical axis v, in the second bending direction 252 toward the power unit 14 by an angle α₂, in which the angle α₂ is greater than 0 degree and up to about 90 degrees. In the examples shown in FIGS. 21-24 where the boom assembly 1100 is depicted in the first and second failed states, respectively, the upper boom portion 1104 is illustrated as being deflected at an angle of approximately 45 degrees with respect to the base mount 1102.

The adapter 1150 and the components thereof may be modular or interchangeable, such that upon failure, the entire adapter 1150, or one or more components thereof, may be removed and replaced and the boom assembly 1100 may be reassembled. For example, with reference to FIGS. 22 and 24, the bent first and second coupling bars 1152′, 1154′ or 1152″, 1154″ may be removed and replaced with new coupling bars. Because the adapter 1150 yields to impact forces applied to the boom assembly 1100, the adapter 1150 may help to prevent damage to the base mount 1102, the upper boom portion 1104, and/or the accessory 300, thereby reducing the cost of replacement, preventing or minimizing the need to repair the truck 10, and reducing the amount of down time before the truck 10 can resume normal operations.

While particular examples of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A boom assembly comprising:
an upper boom portion;
a base mount; and
an adapter coupling the base mount to the upper boom portion, wherein the adapter is configured to (i) maintain the boom assembly in a normal operating position when the upper boom portion is subjected to one or more external forces causing one or more internal forces in the adapter below a yield force threshold of the adapter; and (ii) yield when the upper boom portion is subjected to one or more external forces causing one or more internal forces in the adapter equal to or in excess of the yield force threshold of the adapter,
wherein the adapter comprises an upper element coupled to the upper boom portion, a lower element coupled to the base mount, a first shear pin, a second shear pin, a first gas spring, and a second gas spring, wherein:
when the upper boom portion is subjected to one or more external forces having a force component extending in a first direction causing one or more internal forces in the adapter equal to or in excess of the yield force threshold, the first shear pin breaks and allows the upper element to rotate in a first bending direction, and the first gas spring provides resistance to rotation of the upper element in the first bending direction; and
when the upper boom portion is subjected to one or more external forces having a force component extending in a second direction opposite to the first direction causing one or more internal forces in the adapter equal to or in excess of the yield force threshold, the second shear pin breaks and allows the upper element to rotate in a second bending direction, and the second gas spring provides resistance to rotation of the upper element in the second bending direction.

2. The boom assembly of claim 1, wherein the adapter is configured such that the upper boom portion remains connected to the base mount after the first shear pin fails or the second shear pin fails.

3. The boom assembly of claim 1, wherein the upper element comprises a first extension and a second extension and the adapter further comprises a first arm and a second arm,
wherein a first end of the first gas spring is coupled to the first extension and a second end of the first gas spring is coupled to a first end of the first arm, and wherein a first end of the second gas spring is coupled to the second extension and a second end of the second gas spring is coupled to a first end of the second arm.

4. The boom assembly of claim 3, wherein the upper element further comprises a first stop and a second stop, and wherein when the boom assembly is in the normal operating position, a linear section of the first arm rests against the first stop and a linear section of the second arm rests against the second stop.

5. The boom assembly of claim 1, wherein:
the upper element comprises a pair of upper engagement plates that are received in an upper support body, the upper engagement plates being configured to be received in the upper boom portion to secure the upper boom portion to the upper element; and
the lower element comprises a pair of lower engagement plates that are received in a lower support body, and the lower engagement plates being configured to be received in the base mount to secure the lower element to the base mount.

6. The boom assembly of claim 1, wherein:
when the upper element rotates in the first direction, the boom assembly is in a first shear state, and when the upper element rotates in the second direction, the boom assembly is in a second shear state;
the adapter is configured to hold the upper boom portion at a fixed position relative to the base mount when the boom assembly is in the first or the second shear state.

7. The boom assembly of claim 6, wherein when the boom assembly is in the first or the second shear state, the upper boom portion deflects relative to a vertical axis in the first or the second bending direction by an angle of greater than 0 degrees and up to 90 degrees.

8. A materials handling vehicle comprising:
a power unit;
a load handling assembly extending from the power unit and comprising a pair of forks;
an operator's station comprising an operator's backrest and an operator's platform; and
a boom assembly associated with the materials handling vehicle, wherein the boom assembly comprises a base mount, an upper boom portion, and an adapter coupling the base mount to the upper boom portion,
wherein the base mount comprises a main body extending generally vertically above the operator's platform,
wherein the upper boom portion comprises a first section extending generally vertically above the operator's platform,
wherein the adapter is configured to (i) maintain the boom assembly in a normal operating position when the upper boom portion is subjected to one or more external forces causing one or more internal forces in the adapter below a yield force threshold of the adapter; and (ii) yield when the upper boom portion is subjected to one or more external forces causing one or more internal forces in the adapter equal to or in excess of the yield force threshold of the adapter, and
wherein the adapter comprises an upper element coupled to the upper boom portion, a lower element coupled to the base mount, a first shear pin, a second shear pin, a first gas spring, and a second gas spring, wherein:
when the upper boom portion is subjected to one or more external forces having a force component extending in a first direction causing one or more internal forces in the adapter equal to or in excess of the yield force threshold, the first shear pin breaks and allows the upper element to rotate in a first bending direction, and the first gas spring provides resistance to rotation of the upper element in the first bending direction; and
when the upper boom portion is subjected to one or more external forces having a force component extending in a second direction opposite to the first direction causing one or more internal forces in the adapter equal to or in excess of the yield force threshold, the second shear pin breaks and allows the upper element to rotate in a second bending direction, and the second gas spring provides resistance to rotation of the upper element in the second bending direction.

9. The materials handling vehicle of claim 8, wherein the adapter is configured such that the upper boom portion remains connected to the base mount after the first shear pin fails or the second shear pin fails.

10. The materials handling vehicle of claim 8, wherein the upper element comprises a first extension and a second extension and the adapter further comprises a first arm and a second arm, wherein a first end of the first gas spring is coupled to the first extension and a second end of the first gas spring is coupled to a first end of the first arm, and wherein a first end of the second gas spring is coupled to the second extension and a second end of the second gas spring is coupled to a first end of the second arm.

11. The materials handling vehicle of claim 10, wherein a length of the main body of the base mount is configured so that a junction between the upper and lower elements of the adapter is located a first height above the operator's platform, wherein the first height is greater than an operator height for a 95^{th} percentile adult male.

12. The materials handling vehicle of claim 8, further comprising an accessory coupled to a distal end of the upper boom portion.

13. The materials handling vehicle of claim 12, wherein the upper boom portion comprises a second section extending over the forks perpendicular to the first section, and
wherein a length of the second section of the upper boom portion is configured to position the accessory over the forks.

14. The materials handling vehicle of claim 12, wherein the accessory comprises a camera.

15. The materials handling vehicle of claim 8, wherein the boom assembly is coupled to the operator's backrest.

16. The materials handling vehicle of claim 8, wherein:
when the upper element rotates in the first direction, the boom assembly is in a first shear state, and when the upper element rotates in the second direction, the boom assembly is in a second shear state;
the adapter is configured to hold the upper boom portion at a fixed position relative to the base mount when the boom assembly is in the first or the second shear state.

17. The materials handling vehicle of claim 16, wherein when the boom assembly is in the first or the second shear state, the upper boom portion deflects relative to a vertical axis in the first or the second bending direction by an angle of greater than 0 degrees and up to 90 degrees.
